(19) United States
(12) Patent Application Publication
(10) Pub. No.: US 2004/0073473 A1
(43) Pub. Date: Apr. 15, 2004

(54) Business management method and apparatus

(75) Inventors: Masafumi Dounoue, Kawasaki (JP); Takayasu Koike, Kawasaki (JP); Hiroyuki Fujii, Kawasaki (JP); Osamu Tominaga, Kawasaki (JP); Tatsuhiko Sakamoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/680,317

(22) Filed: Oct. 8, 2003

(30) Foreign Application Priority Data
Oct. 9, 2002 (JP) 2002-295810

(51) Int. Cl. G06F 17/60

(52) U.S. Cl. 705/9

(57) ABSTRACT

This invention provides information to lighten the manager's work load, and to make the staff member accomplish the work in a proper mode. This invention comprises the steps of: based on data received from a terminal of a staff member, registering data concerning the activity state of the staff member and data concerning the settlement state of the problem in the work that the staff member is doing, into the storage device; judging the suitability of the work that the staff member is doing by using a predetermined rule, which is stored in a rule storage, for at least the activity state and the settlement state of the problem, and the data registered in the storage device; and transmitting a manager terminal data representing the suitability of the work that the staff member is doing. Thus, it becomes possible for the manager to do an appropriate judgment without spending time in the information gathering and the analysis.

### TECHNICAL FIELD OF THE INVENTION

This invention relates to an information processing technology for the business management.

### BACKGROUND OF THE INVENTION

For instance, in the past, when the sales manager, who is the business management person, manages the subordinates in his or her charge, the following works happen: (1) to suitably collect the activity information of the subordinates, (2) to judge whether the activity is suitable based on the sales manager's discretion, and (3) to guide and educate the subordinates when it is unsuitable. Since the time and labor are needed to collect such information, there is a problem that the sales manager can not easily take the time for the work of refining the strategy as a whole. In addition, since it is judged based on the sales manager's discretion, there is also a problem that the dispersion of the judgment occurs and its criteria is not leveled. Moreover, as for the guidance and education, it is not clear whether they are appropriate and right to the point of the problem.

Incidentally, Japanese laid open patent application No. 2002-269327 discloses the following matters. That is, it is a sales development support system and sales development support program that objectively grasp and evaluate a progress level necessary for the sales management, and can feed back to the business support. However, the possibility of the success or failure of the negotiation is not able to be presented to the manager by this technique.

Thus, in the background art, it is impossible for the business manager to judge while seeing the possibility of success or failure of the subordinate's work or suitability of the work with the prediction of the future.

### SUMMARY OF THE INVENTION

Therefore, an object of this invention is to provide an information processing technique to provide information to lighten the business manager's workload, and to make each staff member accomplish the work in a proper mode.

A business management method according to a first aspect of this invention comprises the steps of: based on data received from a terminal of a staff member, registering data concerning the activity state of the staff member and data concerning the settlement state of the problem in the work that the staff member is doing, into the storage device; judging the suitability of the work that the staff member is doing by using a predetermined rule, which is stored in a rule storage, for at least the activity state and the settlement state of the problem, and the data registered in the storage device; and transmitting a manager terminal data representing the suitability of the work that the staff member is doing.

Thus, since the data representing the suitability of the staff member's work, is provided to the manager (which includes both of the sales manager and service provider), it becomes possible for the manager to do an appropriate judgment without especially spending time in the information gathering and the analysis. Moreover, though the rule is likely to change dynamically, since the suitability of the work is judged based on the data of the predetermined rule stored in the rule storage, it becomes easy for the manager to suppress the dispersion of the judgment, and to give the appropriate advice.

A business management method according to a second aspect of this invention comprises the steps of: based on data received from a terminal of a staff member, registering data concerning the activity state of the staff member and data concerning the settlement state of the problem in the work that the staff member is doing, into the storage device; judging the suitability of the work that the staff member is doing by using a predetermined rule, which is stored in a rule storage, for at least the activity state and the settlement state of the problem and the data stored in the storage device; and specifying the work, which is judged that there is no suitability, or the staff member, who is doing the work, and transmitting data concerning the work or the staff member to a manager terminal.

Thus, by automatically specifying the work or the staff member with the problem, and notifying the manager of the data concerning the work or the staff member with the problem, the manager can reduce the workload more, and it becomes easy to carry out appropriate measures.

Moreover, the aforementioned judging step may comprise the steps of: comparing a first condition concerning the activity state, which is stored in the rule storage, with the data concerning the activity state of the staff member; and comparing a second condition concerning the settlement state of the problem, which is stored in the rule storage, with the data concerning the settlement state of the problem of the staff member.

Moreover, the aforementioned data representing the suitability of the work may include data representing an area, to which the work belongs, of a plurality of areas predetermined in a space defined by at least a dimension for the data concerning the activity state and a dimension for the data concerning the settlement state of the problem. Thus, since it becomes possible to appropriately represent the business state, it becomes easy to give an appropriate advice.

Incidentally, the above-mentioned method can be executed with the program and the computer, and for instance, this program is stored in the storage medium or the storage device such as the flexible disk, CD-ROM, the magneto-optical disk, the semiconductor memories, or the hard disk. Moreover, this program may be distributed as digital signals through the network, etc. Besides, an intermediate processing result is temporarily stored in the memory.

### BRIEF DESCRIPTION OF THE DRAWINGS

FIG. 1 is a drawing showing an outline of the processing in one embodiment of this invention;

FIG. 2 is a drawing showing a system outline in one embodiment of this invention;

FIG. 3 is a drawing showing one example of data stored in the negotiation phase table;

FIG. 4 is a drawing showing one example of data stored in the password table;

FIG. 5 is a drawing showing one example of data stored in the customer information table;

FIG. 6 is a drawing showing one example of data stored in the negotiation information table;

FIG. 7 is a drawing showing one example of data stored in the negotiator information table;

FIG. 8 is a drawing showing one example of data stored in the successful negotiation data DB;

FIG. 9 is a drawing showing one example of data stored in the failed negotiation data DB;

FIG. 10 is a drawing showing one example of data stored in the threshold DB;

FIG. 11 is a drawing showing one example of data stored in the negotiation results DB;

FIG. 12 is a drawing showing one example of data stored in the problem table;

FIG. 13 is a drawing showing one example of data stored in the daily report results DB;

FIG. 14 is a drawing showing a processing flow of the login processing;

FIG. 15 is a drawing showing one example of the login screen;

FIG. 16 is a drawing showing one example of the menu screen for the sales staff member;

FIG. 17 is a drawing showing one example of the menu screen for the sales manager;

FIG. 18 is a drawing showing one example of the menu screen for the service provider;

FIG. 19 is a drawing showing a processing flow of the daily report input processing;

FIG. 20 is a drawing showing one example of the negotiation selection screen of the daily report input processing;

FIG. 21 is a drawing showing one example of the first daily report input details screen;

FIG. 22 is a drawing showing a part of the processing flow of the daily report input processing;

FIG. 23 is a drawing showing one example of the second daily report input details screen;

FIG. 24 is a drawing showing a part of the processing flow of the daily report input processing;

FIG. 25 is a drawing showing the processing flow of the problem solution rate calculation processing;

FIG. 26 is a drawing showing the distribution of the successful negotiation group and the failed negotiation group in a plane in which the problem solution rate corresponds to the X axis and the activity frequency corresponds to the Y axis;

FIG. 27 is a drawing showing the processing flow of the negotiation state judgment processing;

FIG. 28 is a drawing showing the processing flow of the threshold calculation processing;

FIG. 29 is a drawing showing the processing flow of the processing when the negotiation ends;

FIG. 30 is a drawing showing the processing flow of the new negotiation registration processing;

FIG. 31 is a drawing showing one example of the new negotiation registration screen in the new negotiation registration processing;

FIG. 32 is a drawing showing the processing flow of the problem management processing;

FIG. 33 is a drawing showing one example of the problem management initial screen in the problem management processing;

FIG. 34 is a drawing showing one example of the phase selection screen in the problem management processing;

FIG. 35 is a drawing showing one example of the state updating screen in the problem management processing;

FIG. 36 is a drawing showing the processing flow of the processing for the negotiation phase reference and the state updating;

FIG. 37 is a drawing showing one example of the negotiation selection screen in the processing for the negotiation phase reference and the state updating;

FIG. 38 is a drawing showing one example of the screen for the negotiation phase reference and the state updating;

FIG. 39 is a drawing showing the processing flow of the negotiation information search;

FIG. 40 is a drawing showing one example of the search condition input screen in the negotiation information search;

FIG. 41 is a drawing showing one example of the negotiation selection screen in the negotiation information search;

FIG. 42 is a drawing showing the processing flow to obtain the negotiation list data;

FIG. 43 is a drawing showing one example of the negotiation list screen;

FIG. 44 is a drawing showing the processing flow to obtain the problem negotiation list data;

FIG. 45 is a drawing showing one example of the problem negotiation list screen;

FIG. 46 is a drawing showing the processing flow to obtain the negotiation evaluation data;

FIG. 47 is a drawing showing one example of the negotiation evaluation screen; and

FIG. 48 is a drawing showing the outline of the processing carried out for one negotiation.

### DETAILED DESCRIPTION OF THE PREFERRED EMBODIMENTS

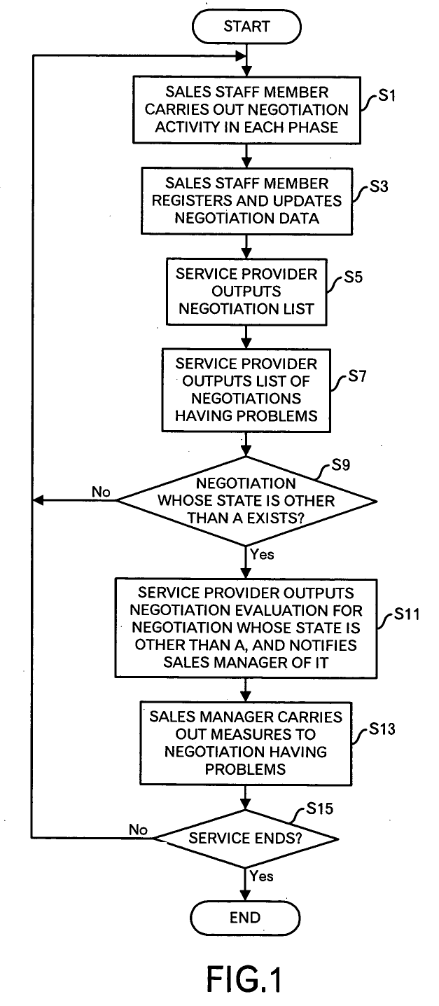

First, the outline of the processing according to one embodiment of this invention is explained by using FIG. 1. Incidentally, though the explanation is carried out for “sales” as an example of the business in the following, this embodiment can be applied to other business. First, each sales staff member carries out the negotiation activity in each phase to the customer (step S1). In this embodiment, the negotiation is divided into nine phases, and the sales staff member carries out necessary activities in each phase. Nine phases are as follows: (1) Initial contact, (2) Relation establishment, (3) Needs grasp, (4) Initial proposal/demonstration execution, (5) Details hearing, (6) Re-proposal, (7) Negotiation on terms and conditions, (8) Preliminary receipt of order, and (9) Receipt of order. Next, each sales staff member registers the negotiation data concerning the performed activity with the sales daily report or the like in a server that the service provider prepared, and updates the negotiation data that has already been registered if it is necessary (step S3). After the step S1 and step S3 are repeated for each negotiation, at a predetermined timing, the service provider that provides the service according to this embodiment of the present invention requests list data of the pending negotiations for the server, and causes it to output the list data of the pending negotiations (step s5). Incidentally, the list includes information representing the negotiation state at the end of the last negotiation phase. The negotiation state is determined based on the registered negotiation data. In this embodiment, the information representing the negotiation state is represented by A, B, C, and D, and A shows that there is no problem, and B, C, and D show that there is a problem. The information representing the negotiation state is information representing possibility of the success or failure of the negotiation. That is, A shows that the possibility of the receipt of the order is high, and the possibility of the receipt of the order is low when the negotiation status is B, C, or D. Incidentally, these detailed contents and the judgment method are described later in detail.

Moreover, the service provider requests list data of the negotiations having problems, that are negotiations judged as B, C, or D, for the server, and causes it to output the list data of the negotiations having problems (step S7). If there is no negotiation having problems, that is, there is no negotiation whose negotiation state is other than A, the processing returns to the step S1 (step S9). However, the service provider may submit the list data of the negotiation to the sales manager. On the other hand, in a case where the negotiation having problems exists, the service provider requests negotiation evaluation data for the negotiation having problems, whose negotiation state is other than A, for the server, causes it to output the negotiation evaluation data, and notifies the sales manager of the negotiation evaluation data (step S11). The sales manager receives the negotiation evaluation data of the negotiation having problems, whose negotiation state is other than A, from the service provider, and carries out appropriate measures for the negotiation having problems based on the negotiation evaluation data (step S13). The above-mentioned steps are repeated until the end of this service (step S15).

By carrying out such processings, even if the sales manager carries out neither the information gathering nor the analysis by himself, since the negotiation having problems is automatically presented, the workload of the sales manager is reduced, and the sales manager can concentrate on the measures for the negotiations having problems and the like. Moreover, since the negotiation evaluation data can be obtained, it becomes possible for the sales manager to derive appropriate measures comparatively easily.

Incidentally, though it was explained in the above that the service provider carries out the steps S5, S7, and S11 in FIG. 1, the sales manager may cause the server prepared by the service provider to carry out them, for example.

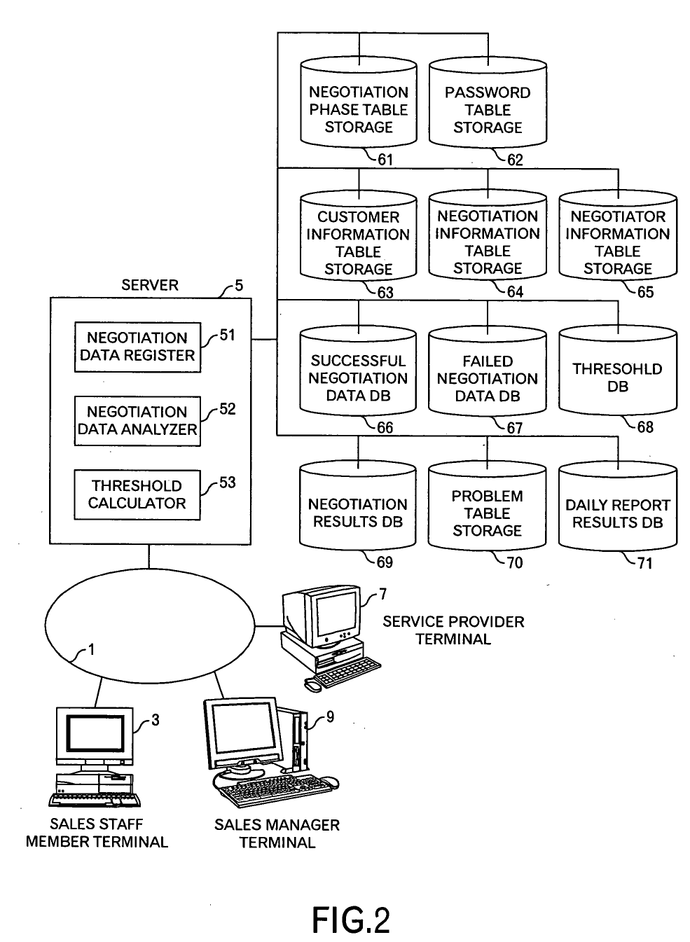

Next, FIG. 2 shows the system outline according to this embodiment of the present invention. For instance, a network 1 such as an in-house LAN (Local Area Network) or the Internet is connected with one or a plurality of sales staff member terminals 3, which are personal computers, for example, operated by sales staff members and having the web browser function, one or a plurality of sale manager terminals 9, which are personal computers, for example, operated by the sale managers and having the web browser function, a server 5 that carries out the main processing in this embodiment and has the web server function, and one or a plurality of service provider terminals 7, which is personal computers, for example, operated by the service provider of the service provided in the server 5 and having the web browser function.

The server 5 includes a negotiation data register 51 for registering negotiation data received from the sales staff member terminal 3 into various databases (DBs) and tables, a negotiation data analyzer 52 for carrying out a processing to judge the negotiation state, and a threshold calculator 53 for calculating the threshold used in judging the negotiation state.

In addition, the server 5 manages a negotiation phase table storage 61 that stores a negotiation phase table including data of phases defined for the negotiation, a password table storage 62 that stores a password table including data of IDs and passwords of users of the server 5, a customer information table storage 63 that stores a customer information table including customer information, a negotiation information table storage 64 that stores a negotiation information table including negotiation information, a negotiator information table storage 65 that stores a negotiator information table including information on the staff members in charge of the negotiations, a successful negotiation data DB 66 that accumulates data of the past negotiations which succeeded, a failed negotiation data DB 67 that accumulates data of the past failed negotiations, a threshold DB 68 that stores thresholds to judge the negotiation state, a negotiation results DB 69 for storing result data of each negotiation, a problem table storage 70 that stores a problem table including problems and settlement states of the problems of each negotiation and the like, and a daily report results DB71 that stores data of daily reports input by the sales staff member.

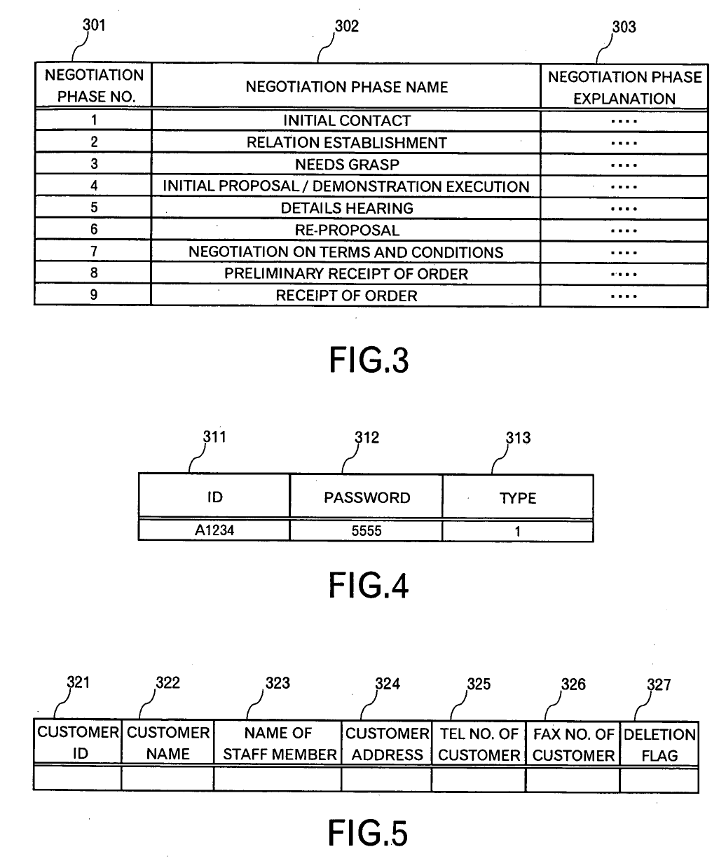

FIG. 3 shows one example of the negotiation phase table stored in the negotiation phase table storage 61. In the example of FIG. 3, the negotiation phase table includes a column 301 of the negotiation phase number, a column 302 of the negotiation phase name, and a column 303 of the negotiation phase explanation. In this embodiment, nine negotiation phases explained above are included. However, it is also possible to use other definition.

FIG. 4 shows one example of the password table stored in the password table storage 62. In the example of FIG. 4, the password table includes a column 311 of the ID, a column 312 of the password, and a column 313 of the type. The type is categorized into the sales staff member, the sales manager, or the service provider (or the system administrator), therefore, in the column 313 of the type, in a case of the sales staff member, “1” is registered, in a case of the sales manager, “2” is registered, and in a case of the service provider, “3” is registered. When the user logs in, this password table is used. Incidentally, the menu presented after the login is different in each value of the column 313 of the type.

FIG. 5 shows one example of the customer information table stored in the customer information table storage 63. In the example of FIG. 5, the customer information table includes a column 321 of the customer ID, a column 322 of the customer name, a column 323 of the name of the staff member name in charge of the customer, a column 324 of the customer address, a column 325 of the contact phone number of the customer, a column 326 of the contact fax number of the customer, and a column 327 of the deletion flag. The deletion flag shows effective with “1”, and shows the deletion with “0”.

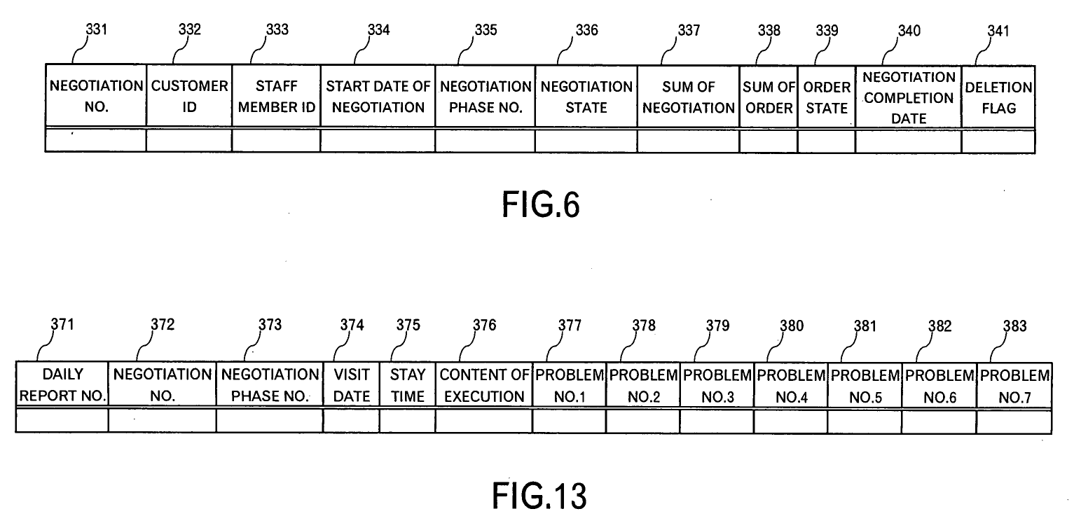

FIG. 6 shows one example of the negotiation information table stored in the negotiation information table storage 64. In the example of FIG. 6, the negotiation information table includes a column 331 of the negotiation number, a column 332 of the customer ID, a column 333 of the staff member ID, a column 334 of the start date of the negotiation, a column 335 of the current negotiation phase number, a column 336 of the negotiation state (A, B, C or D) of the last negotiation phase, a column 337 of a sum of money of the negotiation, a column 338 of a sum of money of the order, a column 339 of the order state, a column 340 of the negotiation completion date, and a column 341 of the deletion flag. The order state is categorized into the unreceived order shown by “0”, the receipt of order shown by “1”, the preliminary receipt of order shown by “2”, the postponement shown by “3”, the defeat shown by “4”, or the disappearance shown by “5”. In addition, the deletion flag shows effective by “1”, and shows the deletion by “0”. However, it is possible to use other definition.

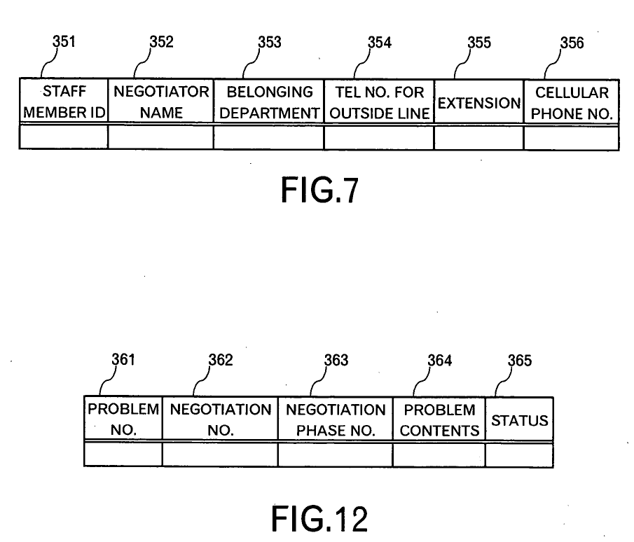

FIG. 7 shows one example of the negotiator information table stored in the negotiator information table storage 65. In the example of FIG. 7, the negotiator information table includes a column 351 of the staff member ID, a column 352 of the name of the negotiator, a column 353 of the belonging department of the negotiator, a column 354 of the negotiator's phone number for the outside line, a column 355 of the negotiator's extension number, and a column 356 of the cellular phone number of the negotiator.

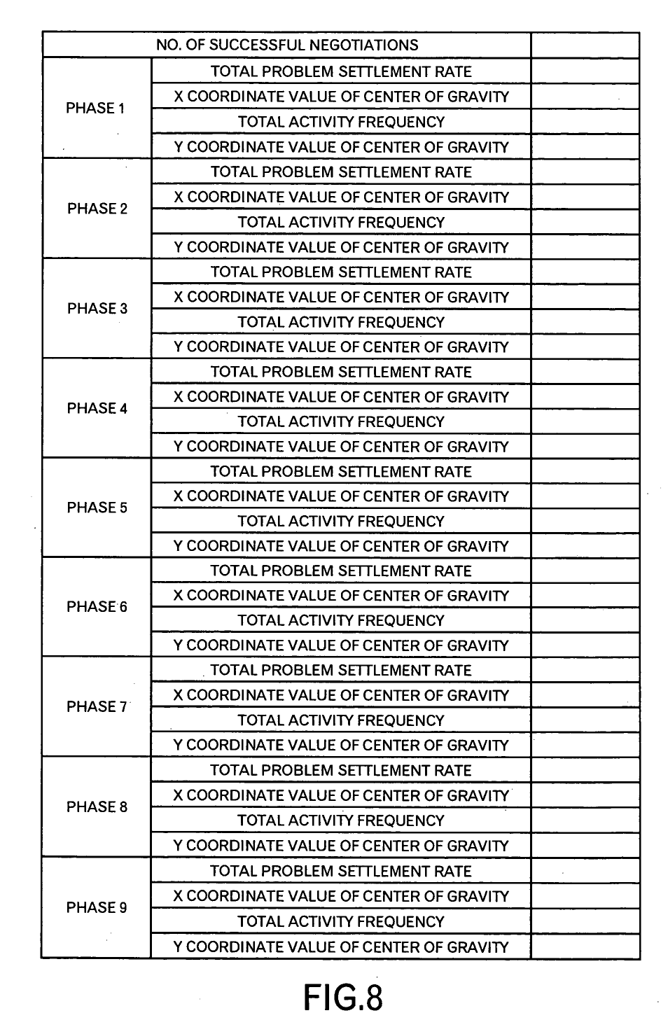

FIG. 8 shows one example of the data stored in the successful negotiation data DB 66. In the example of FIG. 8, the table in the successful negotiation data DB 66 includes a line of the number of successful negotiations, and for each phase, a line of the total problem settlement rate, a line of the X coordinate value of the center of gravity, a line of the total activity frequency, and a line of the Y coordinate value of the center of gravity. Although the details will be explained later, the X axis represents the problem settlement rate, and the Y axis represents the activity frequency. The X coordinate value of the center of gravity is calculated by dividing the problem settlement rate by the number of successful negotiations. In addition, the Y coordinate value of the center of gravity is calculated by dividing the total activity frequency by the number of successful negotiations.

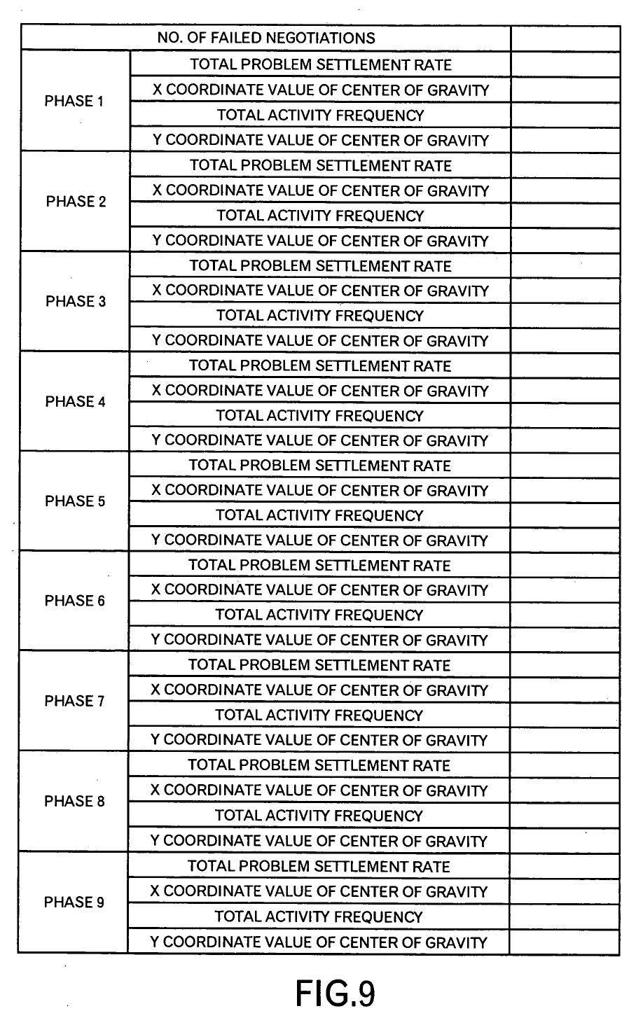

FIG. 9 shows one example of the data stored in the failed negotiation data DB 67. In the example of FIG. 9, the table in the failed negotiation data DB 67 includes a line of the number of failed negotiations, and for each phase, a line of the total problem settlement rate, a line of the X coordinate value of the center of gravity, a line of the total activity frequency, and a line of the Y coordinate value of the center of gravity. As well as the case of the successful negotiation data DB 66, the X axis represents the problem settlement rate, and the Y axis represents the activity frequency. The X coordinate value of the center of gravity is calculated by dividing the problem settlement rate by the number of failed negotiations. In addition, the Y coordinate value of the center of gravity is calculated by dividing the total activity frequency by the number of failed negotiations.

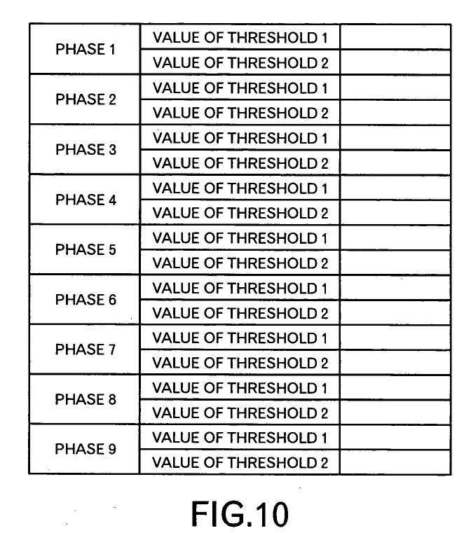

FIG. 10 shows one example of the data stored in the threshold DB 68. In the example of FIG. 10, the table in the threshold DB 68 includes a line of the value of the threshold 1 for the problem settlement rate, and a line of the value of the threshold 2 for the activity frequency for each phase. The concrete calculation method of the threshold 1 and threshold 2 will be explained later.

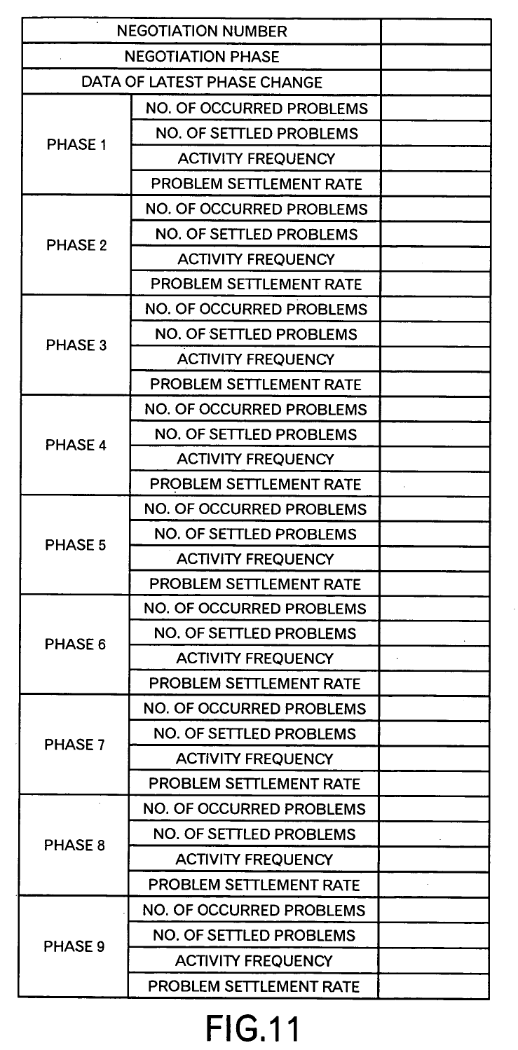

FIG. 11 shows one example of the table stored in the negotiation results DB 69. The table shown in FIG. 11 is a table for one negotiation, and includes a line of the negotiation number, a line of the current negotiation phase, and a line of the date of the latest phase change, and for each phase, a line of the number of occurred problems, a line of the number of the settled problems, a line of the activity frequency, and a line of the problem settlement rate up to the phase. As for the number of occurred problems, only the problems, that occurred in each phase, are counted, but the number of settled problems is counted in the phase in which the problem is solved even if the problem occurred in the past phase. That is, the phase whose number of settled problems is more than the number of occurred problems may exist.

FIG. 12 shows one example of the data stored in the problem table storage 70. In the example of FIG. 12, the problem table includes a column 361 of the problem number issued when it is input by the negotiator, a column 362 of the negotiation number of the negotiation associated with the problem, a column 363 of the negotiation phase number of the negotiation phase at which the problem occurred, a column 364 of contents of the problem, and a column 365 of the status flag of the problem. If the status flag is “0”, it shows that it is pending, and if it is “1”, it shows that it has been settled.

FIG. 13 shows one example of the data stored in the daily report results DB 71. In the example of FIG. 13, the table in the DB 71 includes a column 371 of the daily report number issued when the daily report is input, a column 372 of the negotiation number of the negotiation associated with the daily report, a column 373 of the current negotiation phase number, a column 374 of the visit date to the customer, a column 375 of the stay time at visiting, a column 376 of contents of execution, a column 377 of the relating first problem number, a column 378 of the second problem number, a column 379 of the third problem number, a column 380 of the fourth problem number, a column 381 of the fifth problem number, a column 382 of the sixth problem number, and a column 383 of the seventh problem number. Incidentally, data concerning the contents and status is registered in the column of each problem number.

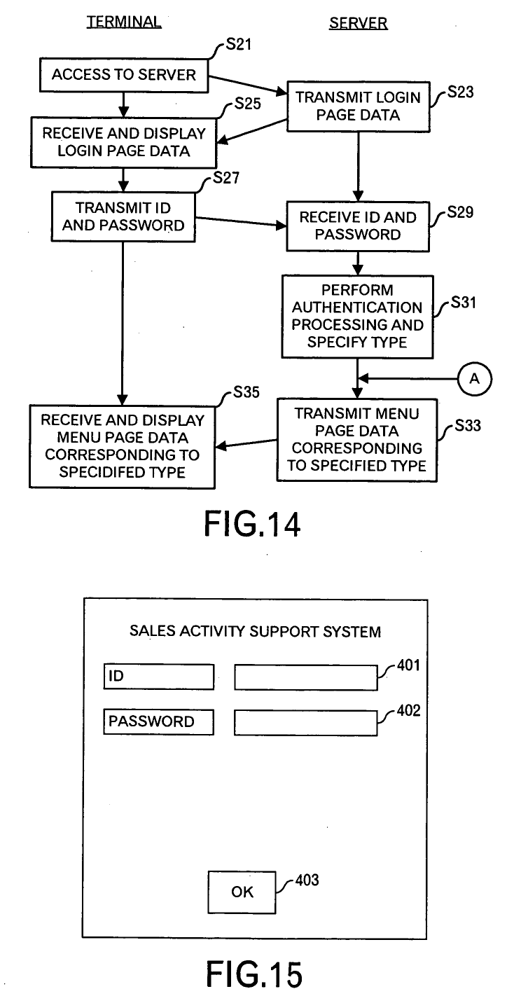

Next, processing flows of the system shown in FIG. 2 will be explained by using FIGS. 14 to 48. First, a processing when the sales staff member, the sales manager and the service provider respectively log in the server 5 by respectively using the sales staff member terminal 3, the sales manager terminal 9, and the service provider terminal 7 is explained by using FIG. 14. The user, who would like to log in, operates own terminal to access the server 5 (step S21). In response to this access, the server 5 transmits the login page data to the terminal (step S23). The page data is data to compose the web page, and includes a file described in the markup language such as HTML (Hyper Text Markup Language) and the image files when the images are embedded into the page, for example. The terminal receives the login page data, and displays it on the display device (step S25). FIG. 15 shows one example of the displayed login page. In the example of FIG. 15, the login page includes a user ID input column 401, a password input column 402, and an OK button 403.

The user inputs own user ID to the user ID input column 401, inputs the password to the password input column 402, and clicks the OK button 403. Then, the terminal transmits the input ID and password to the server 5. The server 5 receives the ID and the password from the terminal (step S29), and refers to the password table stored in the password table storage 62 to carry out the authentication processing. For instance, when the authentication processing is failed, the processing returns to the step S23, and the server 5 requests the re-input of the ID and the password. On the other hand, when the authentication processing succeeded, the server 5 specifies the type of the ID, which is registered in the password table (step S31). Then, the negotiation data register 51 generates menu page data corresponding to the specified type, and transmits to the terminal (step S33). The terminal receives the menu page data from the server 5, and displays it on the display device (step S35).

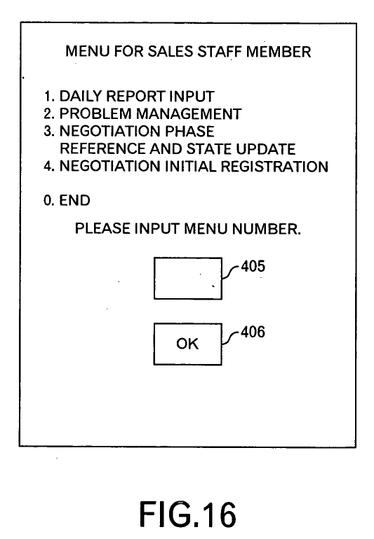

FIG. 16 shows one example of the menu page displayed when the specified type is the sales staff member. In the example of FIG. 16, the page includes menu items “1. daily report input”, “2. problem management”, “3. negotiation phase reference and state update”, “4. negotiation initial registration” and “0. end”, an input column 405 into which the menu number is input, and an OK button 406.

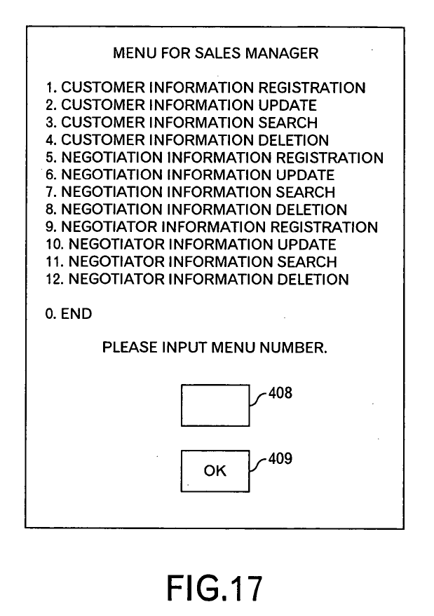

FIG. 17 shows one example of the menu page displayed when the specified type is the sales manager. In the example of FIG. 17, the page includes menu items “1. customer information registration”, “2. customer information update”, “3. customer information search”, “4. customer information deletion”, “5. negotiation information registration”, “6. negotiation information update”, “7. negotiation information search”, “8. negotiation information deletion”, “9. negotiator information registration”, “10. negotiator information update”, “11. negotiator information search”, “12. negotiator information deletion” and “0. end” and a menu number input column 408 and an OK button 409.

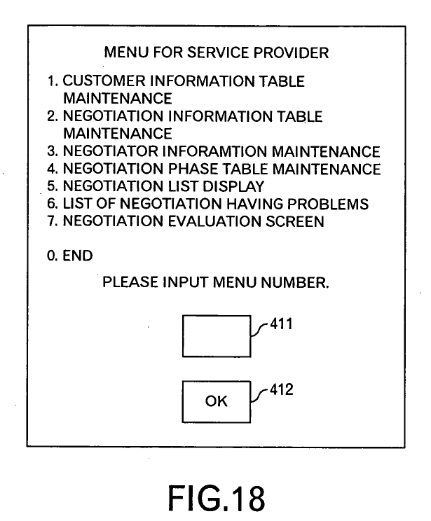

FIG. 18 shows one example of the menu page displayed when the specified type is the service provider. In the example of FIG. 18, the page includes menu items “1. customer information table maintenance”, “2. negotiation information table maintenance”, “3. negotiator information maintenance”, “4. negotiation phase table maintenance”, “5. negotiation list display”, “6. list of negotiation having problems”, “7. negotiation evaluation screen” and “0. end”, and a menu number input column 411, and an OK button 412.

Each user selects a menu item to be carried out from these menu items, inputs the number of the selected menu item to the input column, and clicks the OK button.

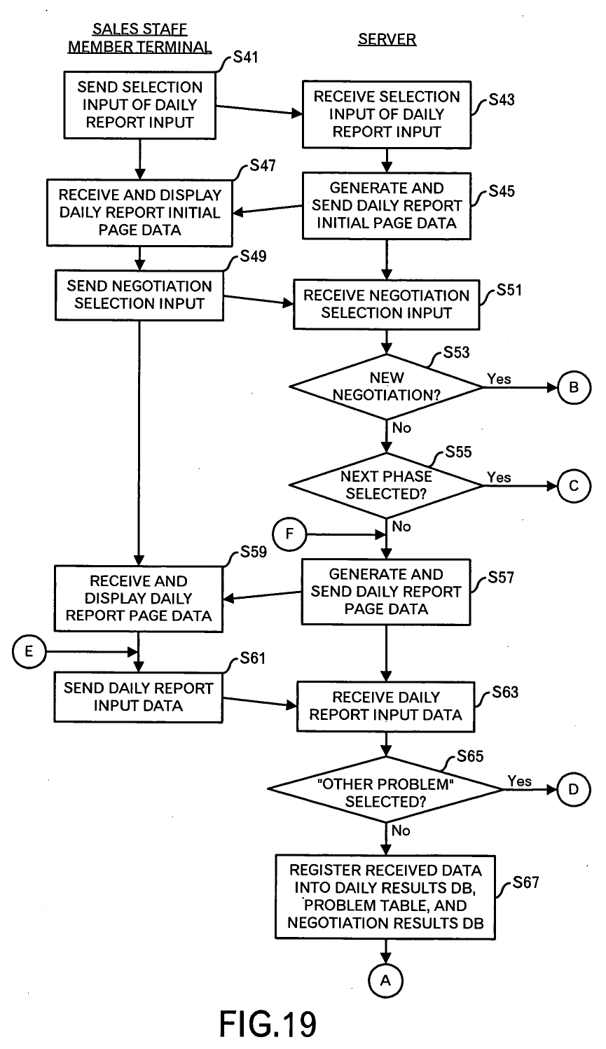

Next, a processing in a case where the user is the sales staff member and selects “1. daily report input” in FIG. 16 is explained by using FIGS. 19 to 29. The sales staff member terminal 3 accepts the selection input of the daily report input by the sales member, and transmits the selection input of the daily report input to the server 5 (step S41). The negotiation data register 51 of the server 5 receives the selection input of the daily report input from the sales staff member terminal 3 (step S43), retrieves the negotiation information table by the ID of the sales staff member, extracts information on the negotiations of which the sales staff member is in charge, and generates daily report initial page data, and transmits it to the sales staff member terminal 3 (step S45) The sales staff member terminal 3 receives the daily report initial page data from the server 5, and displays it on the display device (step S47).

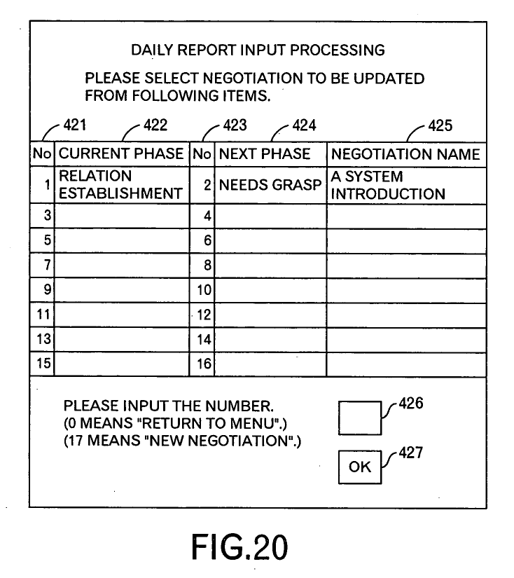

FIG. 20 shows one example of the daily report initial page. In the example of FIG. 20, the page includes a menu table including a column 421 of the menu number, a column 422 of the present negotiation phase, a column 423 of the menu number, a column 424 of the next negotiation phase, and a column 425 of the negotiation name, a menu number input column 426, and an OK button 427. As for each negotiation, the menu number is allocated respectively to the current negotiation phase and the next negotiation phase, and when the user inputs the daily report of the current negotiation phase, he or she inputs the menu number of the current negotiation phase into the menu number input column 426. On the other hand, when the user causes to end the current negotiation phase, he or she inputs the menu number of the next negotiation phase into the menu number input column 426. Incidentally, the processing returns to the menu page shown in FIG. 16 when the user inputs “0” into the menu number input column 426, and the processing shifts to the new negotiation registration page described afterward when the user inputs “17”. Though there is no next negotiation phase when the negotiation is in the final phase, the negotiation data register 51 presents the item “End”, and causes the user to select the end of the negotiation.

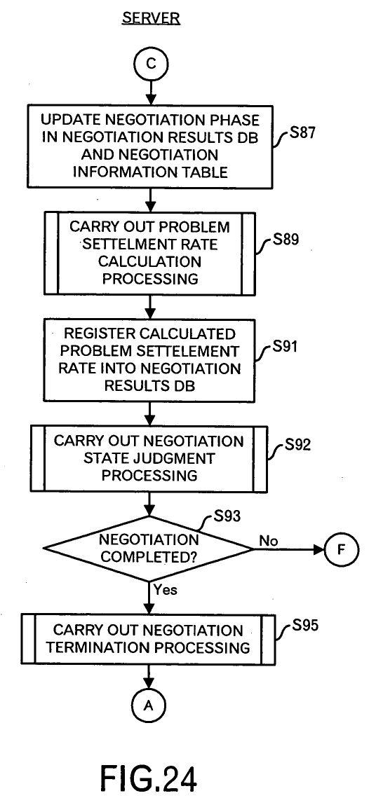

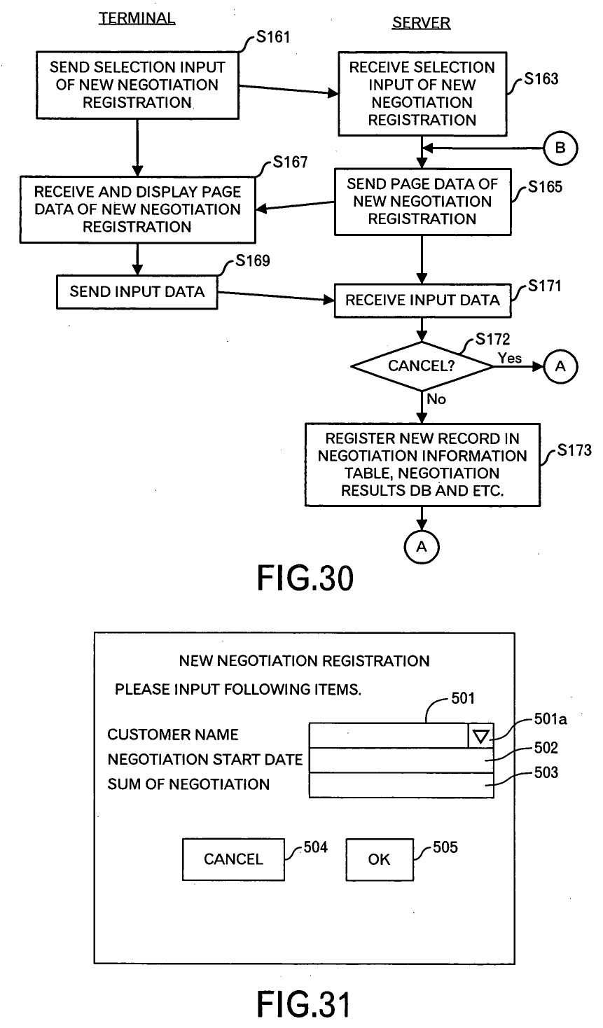

When the sales staff member inputs any of menu numbers into the sales staff member terminal 3, and clicks the OK button 427, the sales staff member terminal 3 accepts the menu number as the negotiation selection input, and transmits the negotiation selection input to the server 5 (step S49). The negotiation data register 51 of the server 5 receives the negotiation selection input from the sales staff member terminal 3 (step S51), and judges whether the new negotiation registration is instructed (step S53). When the new negotiation registration is instructed, the processing shifts to the processing shown in FIG. 30 through the terminal B. On the other hand, when not a new negotiation but the negotiation, that has already been started, is selected, the negotiation data register 51 judges whether the next negotiation phase of the specified negotiation is selected (step S55). When the next negotiation phase of the specified negotiation is selected, the processing shifts to the processing shown in FIG. 24 through the terminal C. When the current negotiation phase of the specified negotiation is selected, the negotiation data register 51 acquires the data of the specified negotiation from the negotiation information table, generates the daily report input page data, and transmits it to the sales staff member terminal 3 (step S57). The sales staff member terminal 3 receives the daily report input page data from the server 5, and displays it on the display device (step S59).

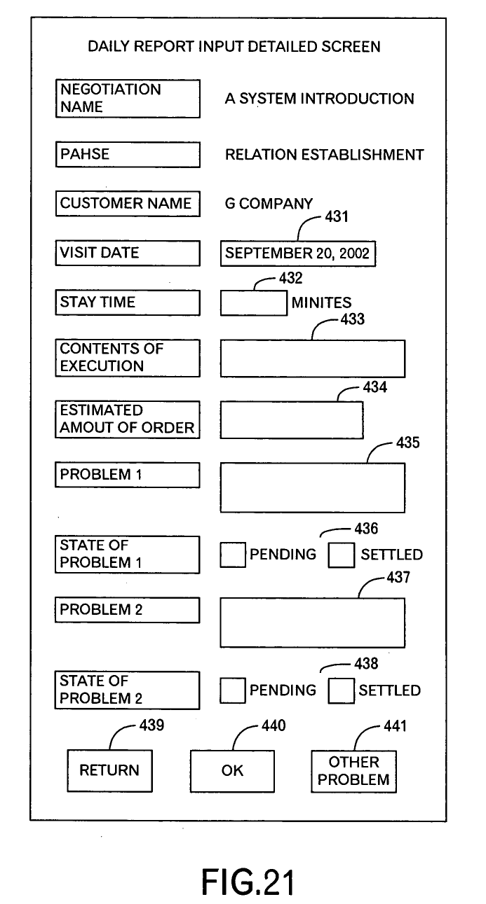

FIG. 21 shows one example of the daily report input page. In the example of FIG. 21, the page includes the indications of the negotiation name, current negotiation phase, and customer name, an input column 431 of the visit date, an input column 432 of the stay time in the customer's place, an input column 433 of contents of execution, an input column 434 of the estimated sum of the order, an input column 435 of contents of the first occurred problem, a state selection column 436 of the first problem, an input column 437 of contents of the second occurred problem, a state selection column 438 of the second problem, a RETURN button 439, an OK button 440, and a button 441 to input other problems. As for the state of each problem, the pending or settled can be selected.

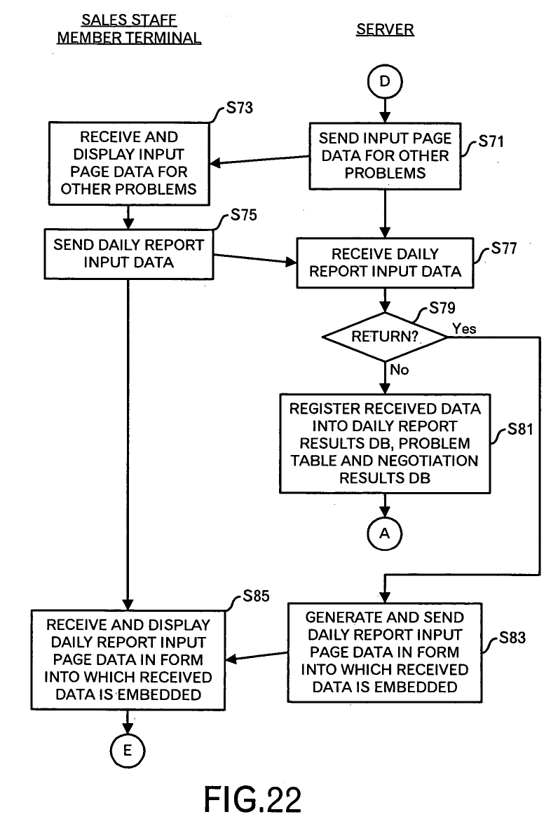

When the sales staff member inputs the daily report data of the performed activity to the sales staff member terminal 3, and clicks the OK button 440 or button 441 for other problems, the sales staff member terminal 3 accepts the daily report input data, and transmits it to server 5 (step S61). The negotiation data register 51 of the server 5 receives the daily report input data from the sales staff member terminal 3, and temporarily stores it into the storage device (step S63). Then, the negotiation data register 51 judges whether the sales staff member clicked the button 441 for other problems (step S65). When the sales staff member clicks the button 441 for other problems, the processing shifts to the processing shown in FIG. 22 through the terminal D. On the other hand, when the sales staff member clicks the OK button 440, the negotiation data register 51 registers the received data into the daily report results DB 71, the problem table stored in the problem table storage 70, the negotiation results DB 69 and the like (step S67). That is, the negotiation data register 51 registers the data input on FIG. 21 and the like into the daily report results DB 71. The problem data input on FIG. 21 and the like is registered into the problem table. The negotiation data register 51 updates and registers the number of occurred problems and the number of settled problems in the current phase into the negotiation results DB 69 based on the input problem data. Then, the processing returns to the step S33 in FIG. 14 through the terminal A. Incidentally, though it is not shown in the figure, when the return button 439 is clicked, the processing returns to the step S33 in FIG. 14 without any registration.

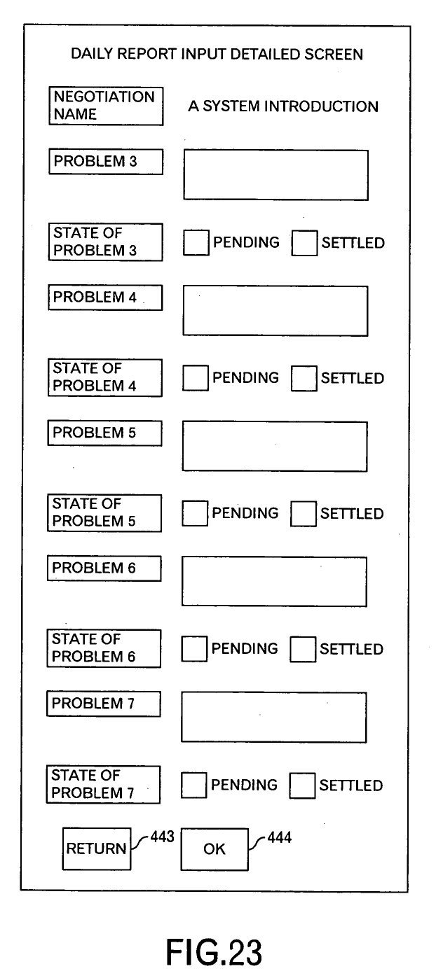

Next, a processing when it is judged at the step S65 that the button 441 for other problems was clicked is explained by using FIG. 22 and FIG. 23. The negotiation data register 51 of the server 5 generates the input page data for other problems, and transmits it to the sales staff member terminal 3 (step S71). The sales staff member terminal 3 receives the input page data for other problems from the server 5, and displays it on the display device (step S73).

FIG. 23 shows one example of the input page of other problems. In the example of FIG. 23, the page includes an indication of the negotiation name, input columns for inputting contents and state for each problem 3 to 7, a return button 443, and an OK button 444. Data for the problem 3 to 7 is input, the OK button 444 is clicked at the registration, and the return button 443 is clicked when temporarily returning to the page of FIG. 21.

Incidentally, the negotiation may end at this phase though it is not shown in the figure. That is, since the negotiation may become the postponement, the defeat or the disappearance, this page may enable a selection input of the negotiation state.

The sales staff member inputs the daily report data into the sales staff member terminal 3 on the page shown in FIG. 23, and clicks the return button 443 or the OK button 444. The sales staff member terminal 3 accepts the daily report input data from the sales staff member, and transmits it to the server 5 (step S75). The negotiation data register 51 of the server 5 receives the daily report input data from the sales staff member terminal 3, and temporarily stores it into the storage device (step S77). Then, the negotiation data register 51 judges whether the return button 443 was clicked (step S79). When it is judged that not the return button 443 but the OK button 444 was clicked, the negotiation data register 51 registers the received data in the daily report results DB 71, the problem table stored in the problem table storage 70, and the negotiation results DB 69 and the like (step S81). That is, the negotiation data register 51 registers the data input on FIG. 21 and FIG. 23 into the daily report results DB 71. It registers the problem data input on FIG. 21 and FIG. 23 into the problem table. It updates and registers the number of occurred problems and the number of settled problems in the current negotiation phase into the negotiation results DB 69 based on the input problem data. Then, the processing returns to the step S33 of FIG. 14 through the terminal A.

On the other hand, when it is judged that the return button 443 was clicked, the negotiation data register 51 generates the daily report input page data in a form into which the data received at the step S63 is embedded, and transmits it to the sales staff member terminal 3 (step S83). The sales staff member terminal 3 receives the daily report input page data from the server 5, and displays it on the display device (step S85). Then, the processing shifts to the step S61 of FIG. 19 through the terminal E.

Thus, only by inputting the daily report that the sales staff member always submits, the negotiation is analyzed as described below, and if there is a problem, he or she can receive the guidance from the sales manager.

Next, a processing when the menu number for the next negotiation phase is selected on the daily report initial page shown in FIG. 20 is explained by using FIG. 24. The negotiation data register 51 of the server 5 updates the current negotiation phase in the negotiation results DB 69 and the negotiation information table stored in the negotiation information table storage 64 to the next negotiation phase (step S87). Moreover, it updates the latest date of the phase change in the negotiation results DB 69. Then, the negotiation data analyzer 52 carries out a problem settlement rate calculation processing in the negotiation phase ended this time (step S89). The problem settlement rate calculation processing will be described afterward in detail. Then, the negotiation data register 51 registers the calculated problem settlement rate into the negotiation results DB 69 so as to correspond to the negotiation phase ended this time (step S91). Moreover, the negotiation data analyzer 52 carries out the negotiation state judgment processing (step S92). This negotiation state judgment processing will be explained afterward in detail. Then, the negotiation data register 51 judges whether the final phase is completed and the negotiation ended (step S93). When the next negotiation phase exists, the processing returns to the step S57 of FIG. 19 through the terminal F. On the other hand, when the final phase is completed and the negotiation ends, the negotiation data register 51 carries out the negotiation termination processing (step S95). Then, the processing returns to the step S33 of FIG. 14 through the terminal A.

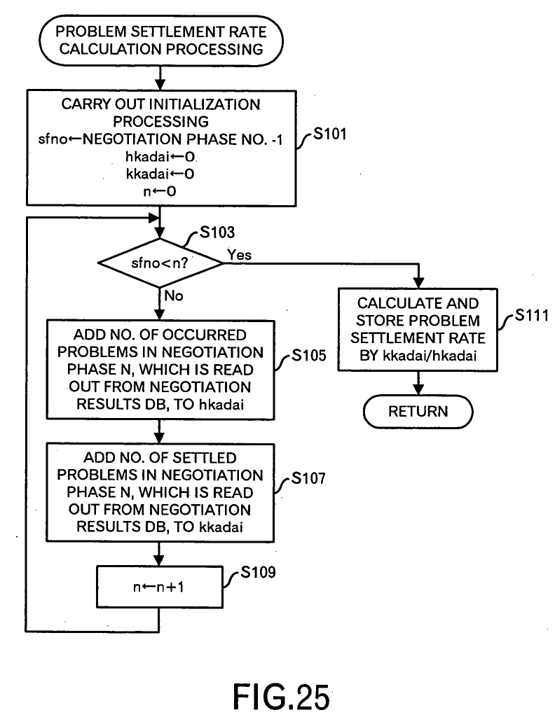

Next, the problem settlement rate calculation processing is explained by using FIG. 25. First, the negotiation data analyzer 52 of the server 5 carries out an initialization processing (step S101). Specifically, it substitutes “negotiation phase number −1” for a variable sfno, and substitutes “0” for variables hkadai, kkadai, and n, respectively. Incidentally, the reason for “negotiation phase number −1” is that it is after the current negotiation phase has already been updated, and the purpose is to calculate the problem settlement rate of the negotiation phase ended this time. In addition, when the final negotiation phase is ended, the negotiation data analyzer 52 substitutes the final negotiation phase number for sfno.

Next, the data analyzer 52 judges whether the variable sfno<n is satisfied (step S103). If the variable sfno≧n, the data analyzer 52 adds the number of occurred problems in the negotiation phase n of the negotiation ID, which is read out from the negotiation results DB 69, to the variable hkadai (step S105). Then, the data analyzer 52 adds the number of settled problems in the negotiation phase n of the negotiation ID, which is read out from the negotiation results DB 69, to the variable kkadai, similarly (step S107). Then, it increments n by 1 (step S109). And, the processing returns to the step S103. Thus, it respectively counts the number of occurred problems and the number of settled problems until the negotiation phase ended this time by using the variables hkadai and kkadai. In the step S103, if it is judged that the counter n has become the next negotiation phase, it calculates the problem settlement rate by dividing kkadai by hkadai, and temporarily stores the calculation result into the storage device (step S111). Then, the processing returns to the former processing.

As mentioned above, the problem settlement rate up to the specific negotiation phase of the specific negotiation is calculated based on the number of occurred problems and the number of settled problems up to the specific negotiation phase.

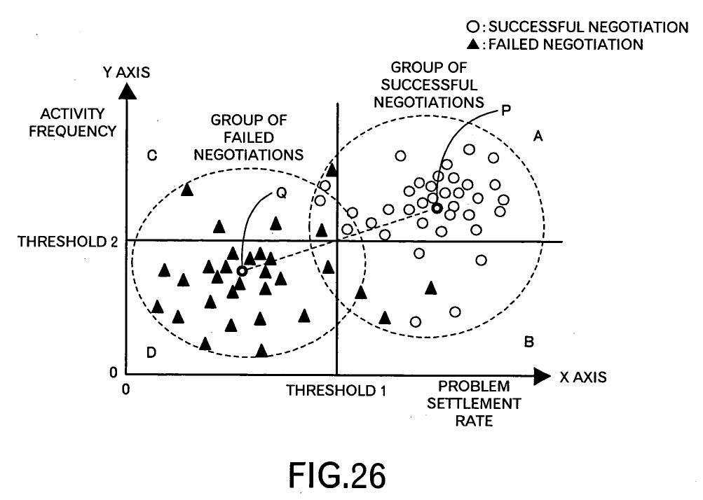

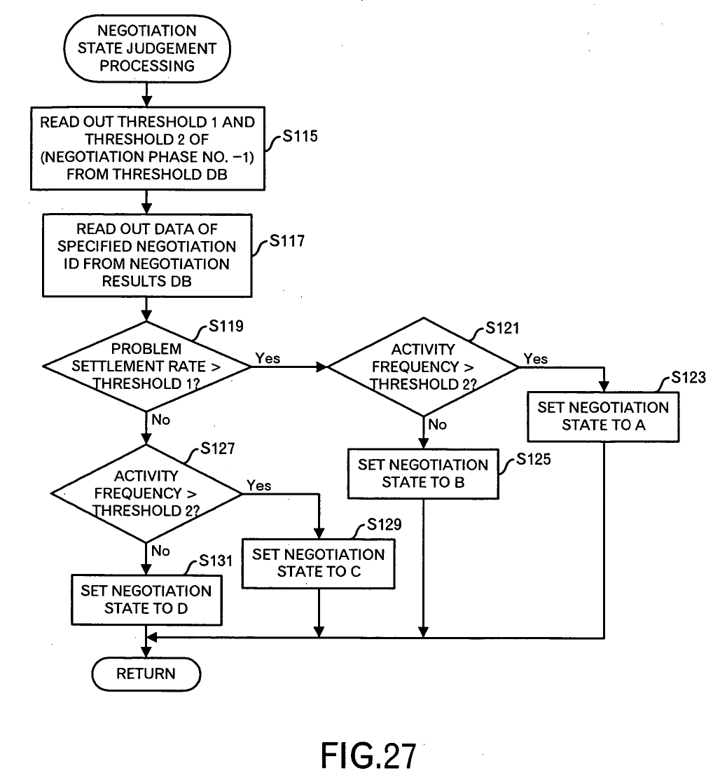

Next, the negotiation state judgment processing is explained by using FIG. 26 and FIG. 27. Before explaining the concrete content of the processing, the details of the negotiation states used in this embodiment are explained. In this embodiment, the negotiation state is automatically judged in each phase. Therefore, in each phase, a plane is assumed in which the problem settlement rate up to that phase corresponds to the X axis, and the activity frequency (visiting frequency to the customer or the like) in that phase corresponds to the Y axis as shown in FIG. 26. The threshold on the X axis is the threshold 1, and the threshold on the Y axis is the threshold 2. On the XY plane, the region in which the problem settlement rate is larger than the threshold 1 and the activity frequency is larger than the threshold 2 is defined as A, the region in which the problem settlement rate is larger than the threshold 1 but the activity frequency is not larger than the threshold 2 is defined as B, the region in which the problem settlement rate is not larger than the threshold 1 but the activity frequency is larger than the threshold 2 is defined as C, and the region in which the problem settlement rate is equal to or less than the threshold 1 and the activity frequency is equal to or less than the threshold 2 is defined as D. The region, to which the negotiation to be processed belongs in the phase, is determined according to the problem settlement rate up to the phase of the negotiation to be processed and the activity frequency in the phase. This region represents the negotiation state of the negotiation to be processed.

Incidentally, the threshold 1 and threshold 2 are calculated from past successful negotiations and the failed negotiations. Before explaining the specific processing flow of the threshold calculation, a simple explanation is provided here. First, the center P of gravity on the XY plane among the group of the successful negotiations is calculated, and the center Q of gravity on the XY plane among the group of the failed negotiations is calculated. In this condition, the X coordinate of the middle point of the segment PQ is the threshold 1, and the Y coordinate thereof is the threshold 2. Therefore, according to the past results, if it is in the region A, the possibility of the success is high. On the other hand, the possibility of the success becomes low, if it is in the regions B, C or D.

More specifically, the successful negotiations are shown on the XY plane as follows.

S1=(S1x,S1y), S2=(S2x,S2y), . . . , Sm=(Smx,Smy)

The failed negotiations are shown on the XY plane as follows.

F1=(F1x,F1y), F2=(F2x,F2y), . . . , Fn=(Fnx,Fny)

And, the X coordinate and Y coordinate of the center of gravity of the group of the successful negotiations are calculated by the following expressions.

X coordinate of the center of gravity of the group of the successful negotiations=(S1x+S2x+ . . . Smx)/m=(ΣSmx)/m

Y coordinate of the center of gravity of the group of the successful negotiations=(S1y+S2y+ . . . Smy)/m=(ΣSmy)/m

The X coordinate and Y coordinate of the center of gravity of the group of the failed negotiations are calculated by the following expressions.

X coordinate of the center of gravity of the group of the failed negotiations=(F1x+F2x+ . . . Fnx)/n=(ΣFnx)/n

Y coordinate of the center of gravity of the group of the failed negotiations=(F1y+F2y+ . . . Fny)/n=(ΣFny)/n

Therefore, the values of the threshold 1 and threshold 2 are calculated as follows:

Value of the threshold 1=(X coordinate of the center of gravity of the group of the successful negotiations+X coordinate of the center of gravity of the group of the failed negotiations)/2=((ΣSmx)/m+(ΣFnx)/n)/2

Value of the threshold 2=(Y coordinate of the center of gravity of the group of the successful negotiations+Y coordinate of the center of gravity of the group of the failed negotiations)/2=((ΣSmy)/m+(ΣFny)/n)/2

Incidentally, the point other than the middle point might be used according to circumstances though the threshold is defined as a middle point of the segment PQ in this embodiment.

The processing flow of the negotiation state judgment processing is shown in FIG. 27. The negotiation data analyzer 52 reads out data of the threshold 1 and threshold 2 of (the current negotiation phase number of the negotiation to be processed −1) from the threshold DB 68 (step S115). When the final negotiation phase ends, the final negotiation phase number is used. Next, the negotiation data analyzer 52 reads data of the problem settlement rate and the activity frequency of (the current negotiation phase number −1) for the negotiation ID of the negotiation to be processed from the negotiation results DB 69 (step S117). Then, the negotiation data analyzer 52 judges whether the read problem settlement rate>the threshold 1 is satisfied (step S119). As a result, it is judged whether it belongs to right part or left part of the straight line of the threshold 1 on the XY plane shown in FIG. 26. If the condition of the step S119 is satisfied, it judges whether the read activity frequency>the threshold 2 is satisfied (step S121). As a result, it is judged whether it belongs to the region A or region B on the XY plane of FIG. 26. Therefore, in a case where the condition of the step S121 is satisfied, since it belongs to the region A, the negotiation data analyzer 52 sets the negotiation state to A, and registers it in the negotiation information table (step S123). On the other hand, in a case where the condition of the step S121 is not satisfied, since the negotiation state belongs to B, the negotiation data analyzer 52 sets the negotiation state to B, and registers it in the negotiation information table (step S125). The processing returns to the former processing after the step S123 or step S125.

If the condition of the step S119 is not satisfied, the negotiation data analyzer 52 judges whether the activity frequency>the threshold 2 is satisfied (step S127). As a result, it is judged whether it belongs to either of the region C and D on the XY plane of FIG. 26. Therefore, in a case where the condition of the step S127 is satisfied, since it belongs to the region C, the negotiation data analyzer 52 sets the negotiation state to C, and registers it in the negotiation information table (step S129). On the other hand, in a case where the condition of the step S127 is not satisfied, the negotiation data analyzer 52 sets the negotiation state to D, and registers it in the negotiation information table (step S131). The processing returns to the former processing after the step S129 or step S131.

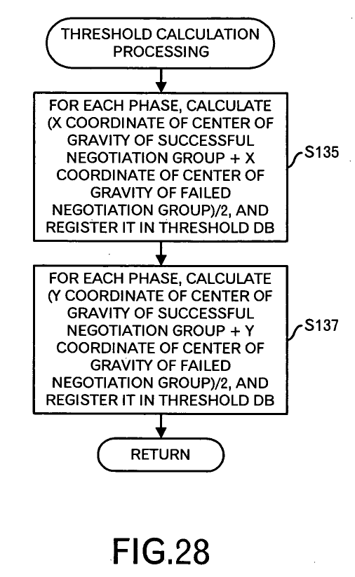

Next, the threshold calculation processing that the threshold calculator 53 executes at an arbitrary timing is explained by using FIG. 28. First of all, the threshold calculator 53 reads out the X coordinate value of the center of gravity of the successful negotiation group of each phase from the successful negotiation data DB 66, and the X coordinate value of the center of gravity of the failed negotiation group of each phase from failed negotiation data DB 67, calculates (the X coordinate value of the center of gravity of the successful negotiation group+the X coordinate value of the center of gravity of the failed negotiation group)/2 for each phases, and registers the result in the threshold DB68 as the threshold 1 (step S135). In addition, it reads out the Y coordinate value of the center of gravity of the successful negotiation group of each phase from the successful negotiation data DB 66 and the Y coordinate value of the center of gravity of the failed negotiation group of each phase from the failed negotiation data DB 67, calculates (the Y coordinate value of the center of gravity of the successful negotiation group+the Y coordinate value of the center of gravity of the failed negotiation group)/2 for each phases, and registers the result in the threshold DB68 as the threshold 2 (step S137).

As a result, a similar calculation to the calculation in the description in association with FIG. 26 is carried out.

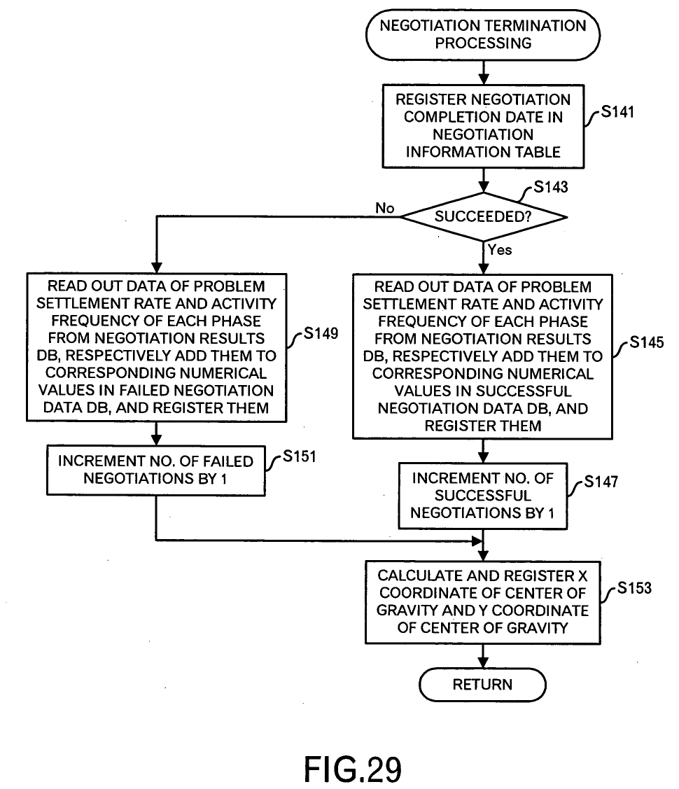

Next, the details of the negotiation termination processing are explained by using FIG. 29. First of all, the negotiation data register 51 registers the negotiation completion date in the negotiation information table (step S141). After that, it judges based on the value of the order state flag in the negotiation information table whether the negotiation succeeded (step S143). If the negotiation succeeded, it reads out data of the problem settlement rate and the activity frequency of each phase of the negotiation from the negotiation results DB 69, respectively adds them to the corresponding numerical values (total problem settlement rate total and total activity frequency) in the successful negotiation data DB 66, and registered the addition result into the successful negotiation data DB 66 (step S145). Then, it increments the number of successful negotiations in the successful negotiation data DB 66 by “1” (step S147). After that, the processing shifts to the step S153.

On the other hand, if the negotiation failed, it reads out data of the problem settlement rate and activity frequency of each phase of the negotiation from the negotiation results DB 69, respectively adds them to the corresponding numerical values in the failed negotiation data DB 67, and registers the addition results in the failed negotiation data DB 67 (step S149). Incidentally, as for the negotiation which failed halfway, because the problem settlement rate and the activity frequency are not registered for all phases, it is not necessary to add them in a case where they are not registered. Moreover, it increments the number of failed negotiations in the failed negotiation data DB 67 by “1” (step S151). After that, the processing shifts to the step S153.

After the step S147 and S151, it calculates the X coordinate of the center of gravity of each phase in the successful negotiation data DB 66 by (the total problem settlement rate/the number of successful negotiations), and the Y coordinate of the center of gravity by (the total activity frequency/the number of successful negotiations), or the X coordinate of the center of gravity of each phase in the failed negotiation data DB 67 by (the total problem settlement rate/the number of failed negotiations), and the Y coordinate of the center of gravity by (the total activity frequency/the number of failed negotiations), and registers them in the successful negotiation data DB 66 or the failed negotiation data DB 67 (step S153).

Thus, it becomes possible to easily calculate the thresholds as shown in FIG. 28.

The processing in a case where it is judged that the new negotiation registration was instructed at the step S53 of FIG. 19 or where it is judged that the negotiation initial registration was instructed on the menu page of FIG. 16 is explained by using FIGS. 30 and 31. Incidentally, when “5. negotiation information registration” is selected on the menu page for the sales manager shown in FIG. 17, this processing is carried out. When the instruction of the new negotiation registration is input to the terminal by the sales staff member or the sales manager, the terminal accepts the selection input of the new negotiation registration, and transmits the selection input of the new negotiation registration to the server 5 (step S161). The negotiation data register 51 of the server 5 receives the selection input of the new negotiation registration from the terminal (step S163), and transmits page data of the new negotiation registration to the terminal (step S165). The terminal receives the page data of the new negotiation registration from the server 5, and displays it on the display device (step S167).

One example of the new negotiation registration page is shown in FIG. 31. In the example of FIG. 31, the page includes an input or selection column 501 of the customer name, an input column 502 of the negotiation start date, an input column 503 of the sum of money of the negotiation, a cancel button 504, and an OK button 505. Incidentally, it is possible to display the customer list registered in the customer information table by the pull-down menu when clicking the button 501a to select the customer from the customer list, and it is also possible to directly input the customer name. The user clicks the cancel button 504 when the new negotiation registration is canceled, and when a new negotiation is registered, the user clicks the OK button 505. Incidentally, input columns for further inputting negotiation information may be provided. Moreover, the button or the like to return to the former processing may be provided in a case where the processing shifts to this processing through the terminal B.

The terminal that accepts the data input and the click of the button by the sales staff member or the sales manager transmits the input data to the server 5 (step S169). The negotiation data register 51 receives the input data from the terminal, and temporarily stores it in the storage device (step S171). Then, it judges whether the cancel button 504 was clicked (step S172). The processing returns to the step S33 of FIG. 14 through the terminal A discarding the received data, in a case where it is judged that the cancel button 504 was clicked. On the other hand, it registers a new record in the negotiation information table and negotiation results DB 69 by using the received data in a case where it is judged that the OK button 505 was clicked (step S173). Then, the processing returns to the step S33 of FIG. 14 through the terminal A.

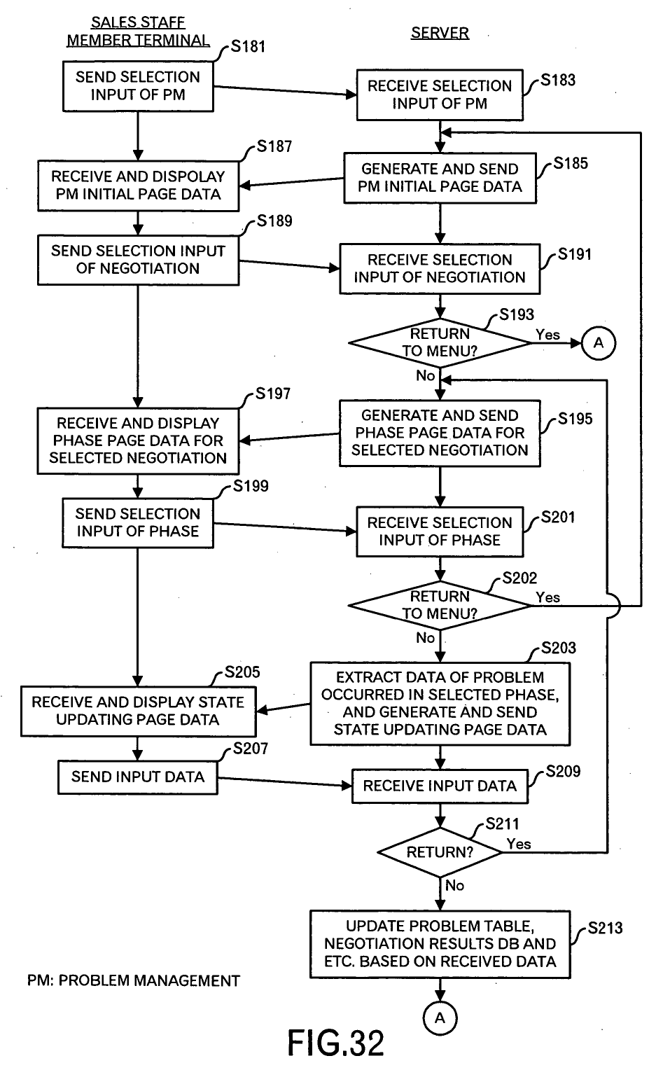

Next, the processing in a case where “2. problem management” is selected on the menu page for the sales staff member shown in FIG. 16 is explained by using FIGS. 32 to 35. When the selection input of the problem management is carried out by the sales staff member, the sales staff member terminal 3 accepts the selection input of the problem management, and transmits the selection input of the problem management to the server 5 (step S181). The negotiation data register 51 of the server 5 receives the selection input of the problem management from the sales staff member terminal 3 (step S183), retrieves the negotiation information table stored in the negotiation information table storage 64 with the user ID, generates the problem management initial page data by using the obtained negotiation data, and transmits it to the sales staff member terminal 3 (step S185). The sales staff member terminal 3 receives the problem management initial page data from the server 5, and displays it on the display device (step S187).

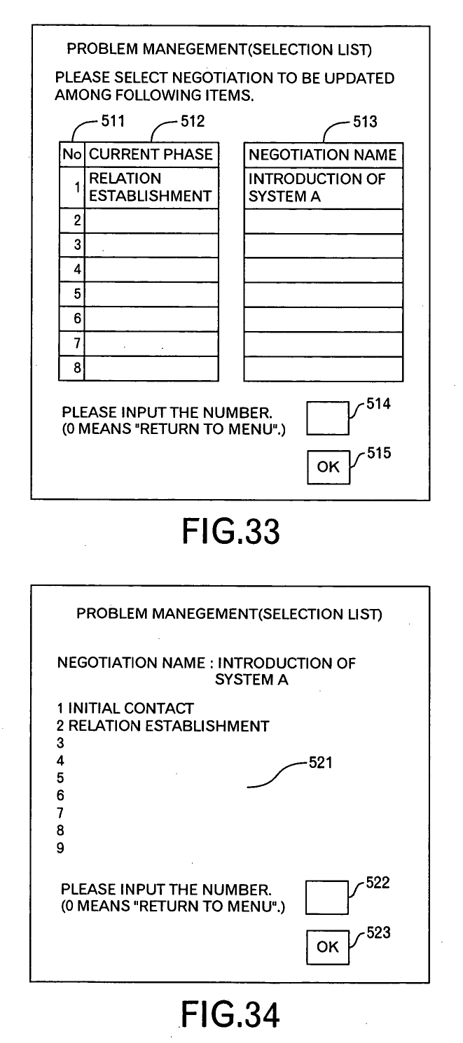

One example of the problem management initial page is shown in FIG. 33. In the example of FIG. 33, the page includes a table including a column 511 of the menu number, a column 512 of the current negotiation phase name, and a column 513 of the negotiation name, and a menu number input column 514 and an OK button 515. The sales staff member inputs the menu number set for the related negotiation on this screen into the menu number input column 514 to input the settled problem, for instance, and clicks the OK button 515. Incidentally, “0” is input to the menu number input column 514 when returning to the menu.

The sales staff member terminal 3 accepts the selection input of the negotiation by the sales staff member, and transmits the selection input of the negotiation to the server 5 (step S189). The negotiation data register 51 of the server 5 receives the selection input of the negotiation from the sales staff member terminal 3 (step S191), and judges whether the returning to the menu page was instructed (step S193). In a case where it is judged that the returning to the menu page was instructed, the processing returns to the step S33 of FIG. 14 through the terminal A. On the other hand, when any of the negotiations is selected, it refers to the negotiation phase table to read out the negotiation phase name before the current phase, generates the phase page data for the selected negotiation, and transmits it to the sales staff member terminal 3 (step S195). The sales staff member terminal 3 receives the phase page data from the server 5, and displays it on the display device (step S197).

One example of the phase page data is shown in FIG. 34. In the example of FIG. 34, the page includes a phase list 521, a phase number input column 522, and an OK button 523. Incidentally, because the current negotiation phase is the relation establishment in this example, and any negotiation phase following that is never selected, they are not displayed. The sales staff member selects the phase at which the problem occurred, and inputs the phase number to the phase number input column 522, and clicks the OK button 523. Incidentally, “0” is input to the phase number input column 522 when returning to the menu.

The sales staff member terminal 3 accepts the selection input of the phase by the sales staff member, and transmits the selection input of the phase to the server 5 (step S199). The negotiation data register 51 of the server 5 receives the selection input of the phase from the sales staff member terminal 3 (step S201), and judges whether the returning to the menu is instructed (step S202). The processing returns to the step S185 when it is instructed to return to the menu. Incidentally, it is also possible to return to the step S33 of FIG. 14 through the terminal A. On the other hand, when any of the negotiation phases is selected, it extracts data of the problem that occurs in the selected negotiation and the negotiation phase from the problem table, generates the state updating page data, and transmits it to the sales staff member terminal 3 (step S203). The sales staff member terminal 3 receives the state updating page data from the server 5, and displays it on the display device (step S205).

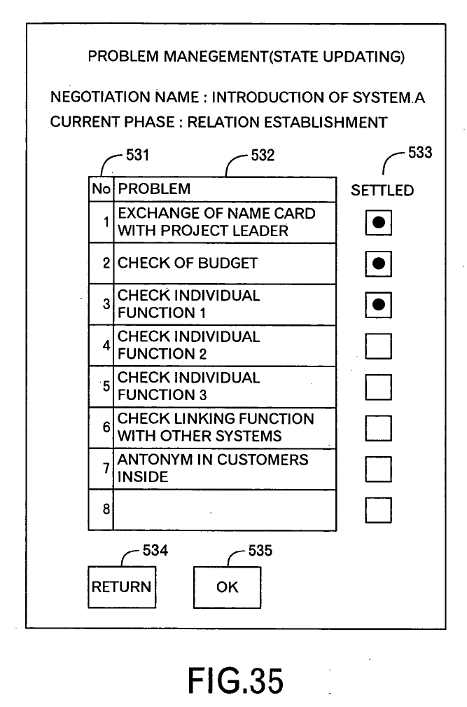

One example of the state updating page is shown in FIG. 35. In the example of FIG. 35, the page includes a table having a column 531 of the problem number, a column 532 of the problem name, and a settlement check column 533, a return button 534, and an OK button 535. After confirming the problem that occurred in the selected negotiation phase, the sales staff member checks the settlement check column 533 for the settled problem. Then, he or she clicks the OK button 535. The return button 534 is clicked when returning to the previous page. Incidentally, the problem set to “settled” may be returned to “unsettled”.

The sales staff member terminal 3 accepts input data by the sales staff member, and transmits the input data to the server 5 (step S207). The negotiation data register 51 of the server 5 receives the input data from the sales staff member terminal 3, and temporarily stores it in the storage device (step S209). Then, it judges whether the return button 534 was clicked (step S211) The processing returns to the step S195 in a case where it is judged that the return button 534 was clicked. On the other hand, it updates the problem table and the negotiation results DB 69 based on the received data when it is judged that the OK button 535 was clicked (step S213). Here, it changes the status flag of the problem in the problem table to “0” when changing to unsettled, and changes the status flag to “1” when changing to settled. Moreover, the number of settled problems in the current negotiation phase of the negotiation is increased or decreased in the negotiation results DB 69. Then, the processing returns to the step S33 of FIG. 14 through the terminal A.

It becomes possible for the sales staff member to change the state of the problem that occurred in the past by such processing.

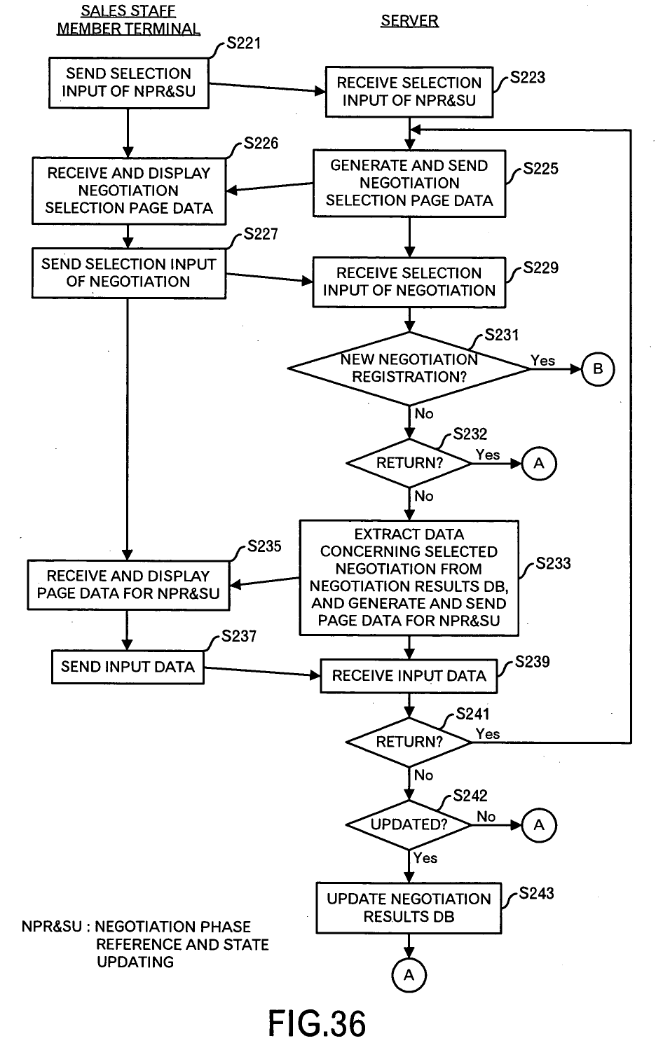

Next, the processing when “3. negotiation phase reference and the state updating” is selected on the menu page for the sales staff member in FIG. 16 is explained by using FIGS. 36 to 38. First, when the sales staff member selects “3. negotiation phase reference and the state updating” on the menu page, the sales staff member terminal 3 accepts the selection input of the negotiation phase reference and the state updating, and transmits the selection input to the server 5 (step S221). The negotiation data register 51 of the server 5 receives the selection input of the negotiation phase reference and the state updating from the sales staff member terminal 3 (step S223), searches the negotiation information table with the sales staff member ID to generate the negotiation selection page data, and transmits it to the sales staff member terminal 3 (step S225). The sales staff member terminal 3 receives the negotiation selection page data from the server 5, and displays it on the display device (step S227).

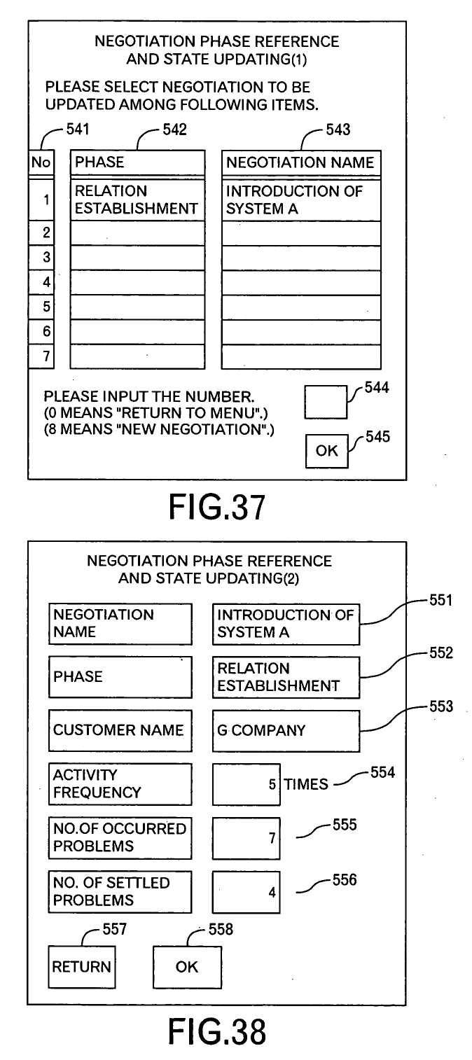

One example of the negotiation selection page is shown in FIG. 37. In the example of FIG. 37, the page includes a table having a column 541 of the menu number, a column 542 of the current negotiation phase name, and a column 543 of the negotiation name, a menu number input column 544, and an OK button 545. Here, the sales staff member selects any of the displayed negotiations, inputs the menu number of the negotiation into the menu number input column 544, and clicks the OK button 545. Incidentally, it is also possible to register a new negotiation by inputting “8” into the menu number input column 544, and to return-to the menu page by inputting “0” to the menu number input column 544.

The sales staff member terminal 3 accepts the selection input of the negotiation by the sales staff member, and transmits the selection input of the negotiation to the server 5 (step S227). The negotiation data register 51 of the server 5 receives the selection input of the negotiation selection from the sales staff member terminal 3 (step S229), and judges whether the new negotiation registration was selected (step S231). If it is judged that the new negotiation registration was selected, the processing returns to the step S165 of FIG. 30 through the terminal B. Moreover, it judges whether it was instructed to return to the menu (step S232). The processing returns to the step S33 of FIG. 14 through the terminal A in a case where it is judged that the returning to the menu was instructed. When it is judged that any of the negotiations was selected, it extracts data concerning the selected negotiation from the negotiation results DB 69, and generates and transmits page data for the negotiation phase reference and the state updating to the sales staff member terminal 3 (step S233). The sales staff member terminal 3 receives the page data for the negotiation phase reference and the state updating from the server 5, and displays it on the display device (step S235).

One example of the page of the negotiation phase reference and the state updating is shown in FIG. 38. In the example of FIG. 38, the page includes a negotiation name display column 551, a phase display column 552, a customer name display column 553, an activity frequency display and input column 554, a display and input column 555 of the number of occurred problems, a display and input column 556 of the number of settled problems, a return button 557, and an OK button 558. The sales staff member confirms the negotiation phase, and, according to circumstances, changes numerical values of the activity frequency, the number of occurred problems, and the number of settled problems. Then, he or she clicks the OK button 558 or return button 557.

The sales staff member terminal 3 accepts data input by the sales staff member, and transmits the input data to the server 5 (step S237). The negotiation data register 51 of the server 5 receives the input data from the sales staff member terminal 3, and temporarily stores it in the storage device (step S239). Then, it judges whether the return button 557 was clicked (step S241). The processing returns to the step S225 when it is judged that the return button 557 was clicked. It judges whether updating is carried out to the data of the activity frequency and the like, when it is judged that the return button 557 was not clicked (step S242) The processing returns to the step S33 of FIG. 14 through the terminal A when it is judged that data is not updated and only the reference was carried out. It updates the negotiation results DB 69 based on the received data when it is judged that the data is updated (step S243). Then, the processing returns to the step S33 of FIG. 14 through the terminal A.

Thus, when the sales staff member wants to update only the numerical values such as the activity frequency, the number of occurred problems, and the number of settled problems and to refer to the numerical values, the processing flow of FIG. 36 is executed.

Because each menu item in the menu for the sales manager, which is shown in FIG. 17, hardly differs from the usual database reference and is not the main part of this embodiment, the explanation is omitted excluding the negotiation information search, which will be explained later.

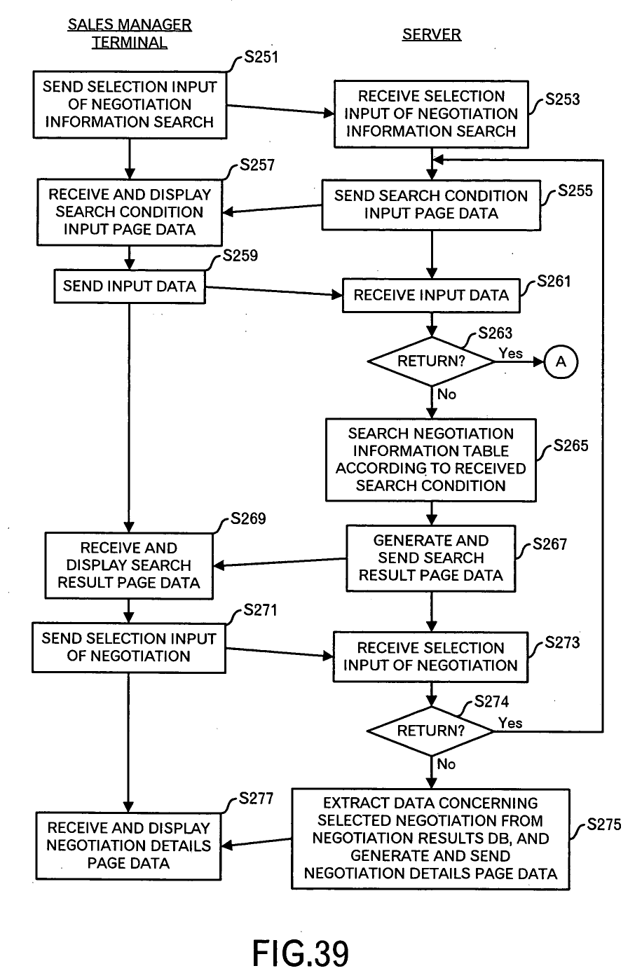

The processing flow of the negotiation information search by the sales manager is explained by using FIGS. 39 to 41. First, the sales manager selects “7. negotiation information search” on the menu page for the sales manager, inputs the menu number into the menu number input column 408, and clicks the OK button 409. The sales manager terminal 9 accepts the selection input of the negotiation information search from the sales manager, and transmits the selection input to the server 5 (step S251). The negotiation data register 51 of the server 5 receives the selection input of the negotiation information search from the sales manager terminal 9 (step S253), and transmits the search condition input page data to the sales manager terminal 9 (step S255). The sales manager terminal 9 receives the search condition input page data from the server 5, and displays it on the display device (step S257).

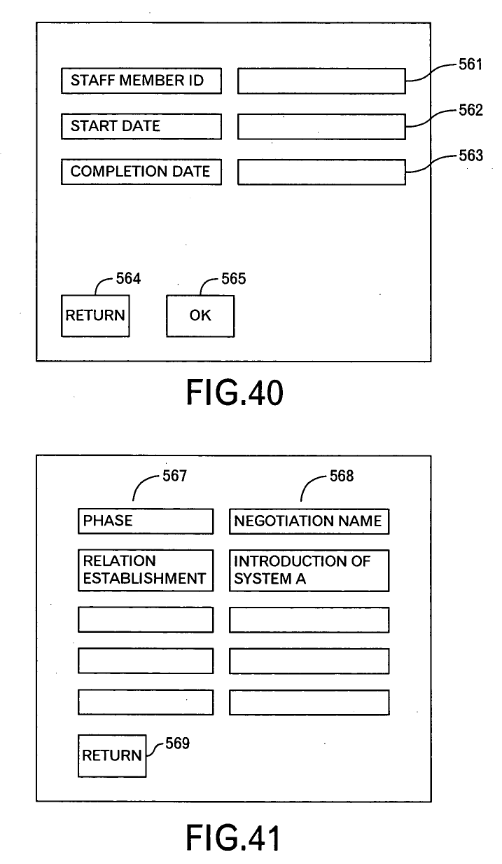

One example of the search condition input page is shown in FIG. 40. In the example of FIG. 40, the page includes an input column 561 of the sales staff member ID an input column 562 of the beginning date as a search condition of the negotiation start date, an input column 563 of the completion date as a search condition of negotiation completion date, a return button 564, and an OK button 565. The sales manager inputs at least the sales staff member ID into input the column 561, clicks the OK button 565 or clicks the return button 564. Incidentally, it is also possible to configure so as to input any other conditions.

The sales manager terminal 9 accepts data input by the sales manager, and transmits the input data to the server 5 (step S259) The negotiation data register 51 of the server 5 receives the input data from the sales manager terminal 9, and temporarily stores it in the storage device (step S261). Then, it judges whether the return button 564 was clicked (step S263). The processing returns to the step S33 of FIG. 14 through the terminal A in a case where the return button 564 was clicked. On the other hand, it searches the negotiation information table according to the search condition included in the received data in a case where it is judged that the OK button 565 was clicked (step S265). Then, it generates the search result page data, and transmits it to the sales manager terminal 9 (step S267). The sales manager terminal 9 receives the search result page data from the server 5, and displays it on the display device (step S269).

One example of the search result page is shown in FIG. 41. In the example of FIG. 41, the page includes a display column 567 of the current negotiation phase of the negotiation as search results, a button display column 568 of the negotiation name as search results, and a return button 569. The negotiation name is a button, and to see details, the button of the negotiation name is clicked. The return button 569 is clicked when returning to the previous page.

The sales manager terminal 9 accepts the selection input of the negotiation from the sales manager, and transmits the selection input of the negotiation to the server 5 (step S271). The negotiation data register 51 of the server 5 receives the selection input of the negotiation from the sales manager terminal 9 (step S273), and judges whether the return button 569 was clicked (step S274). The processing returns to the step S255 in a case where it is judged that the return button 569 was clicked. On the other hand, in a case where it is judged that any of the negotiations was selected, it searches the negotiation results DB 69 and/or the negotiation information table for the selected negotiation, extracts the relating negotiation data, generates negotiation details page data, and transmits it to the sales manager terminal 9 (step S275). The sales manager terminal 9 receives the negotiation details page data from the server 5, and displays it on the display device (step S277).

Thus, the sales manager can confirm the state and the like by retrieving the negotiations of subordinate sales staff members.

Next, processings corresponding to some menu items in the menu for the service provider in FIG. 18 will be explained. Because it is for the maintenance, the explanation for the items 1 to 4 in the menu for the service provider in FIG. 18 is omitted here. Moreover, though “5. negotiation list display”, “6. problem negotiation list” and “7. negotiation evaluation screen” are explained later, there is a case where these are included in not only the menu for the service provider but also the menu for the sales manage, and in this case, not the service provider but the sales manager operates the sales manager terminal 9 to obtain the information.

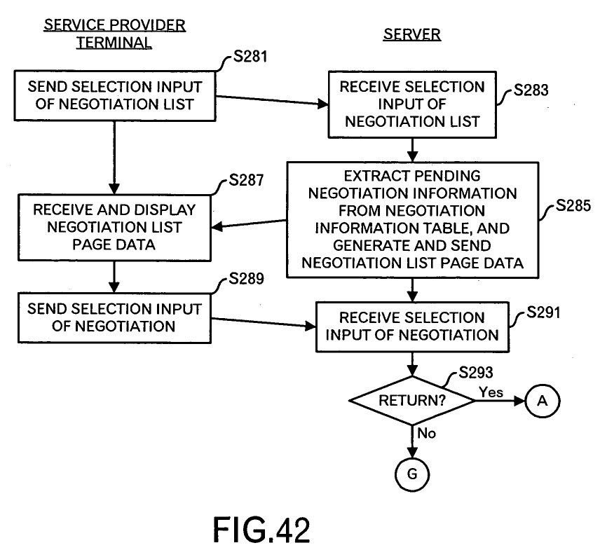

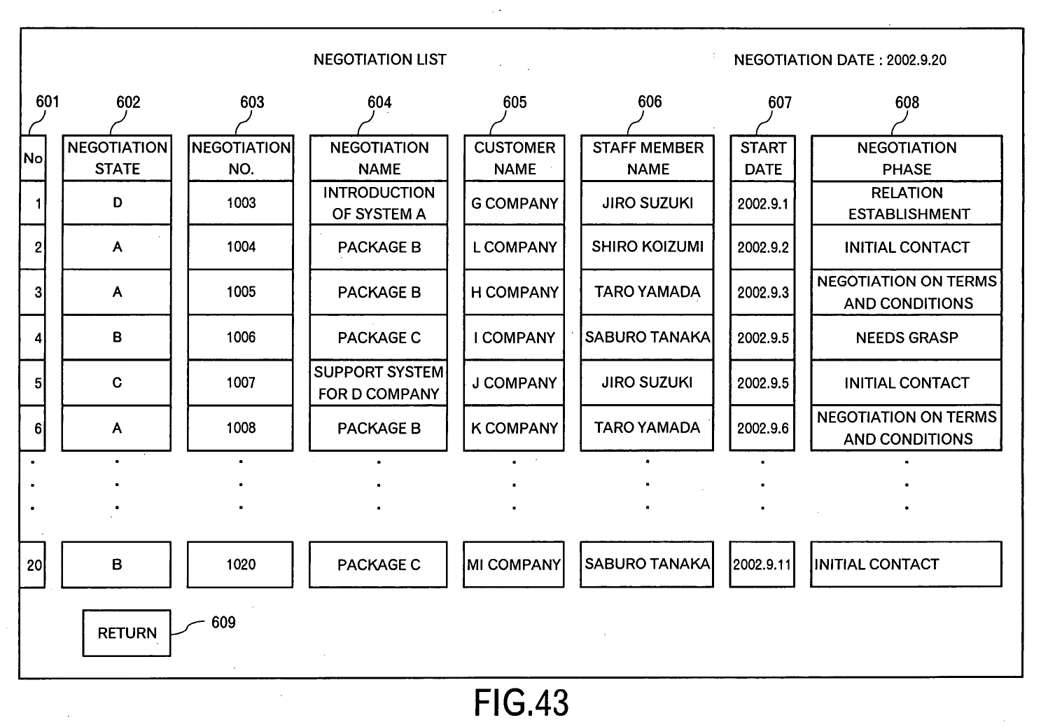

First of all, the processing when the service provider selects “5. negotiation list display” in the menu for the service provider is explained by using FIG. 42 and FIG. 43. The service provider terminal 7 accepts the selection input of the negotiation list display by the service provider, and transmits the selection input to the server 5 (step S281). The negotiation data analyzer 52 of the server 5 receives the selection input of the negotiation list display from the service provider terminal 7 (step S283), and extracts information of pending negotiations from the negotiation information table. Then, it generates the negotiation list page data, and transmits it to the service provider terminal 7 (step S285). Incidentally, the sales information table is assumed to be provided for each company or each sales manager. If necessary, after the company or the sales manager is specified, the step S285 is executed. The service provider terminal 7 receives the negotiation list page data, and displays it on the display device (step S287) One example of the negotiation list page is shown in FIG. 43. In the example of FIG. 43, the page includes a table including a column 601 of the line number, a column 602 of the negotiation state, a column 603 of the negotiation number, a column 604 of the negotiation name, a column 605 of the customer name, a column 606 of the negotiation staff member name, a column 607 of the negotiation start date, and a column 608 of the current negotiation phase, and a return button 609. Incidentally, a button to download the file for the print or the like may be provided. Moreover, each negotiation name in the column 604 of the negotiation name is a button, and the transition to the evaluation page of the negotiation is carried out when any of the negotiation name is clicked. In FIG. 43, since it is a negotiation list, even if the negotiation is in any negotiation state, they are displayed on the list.

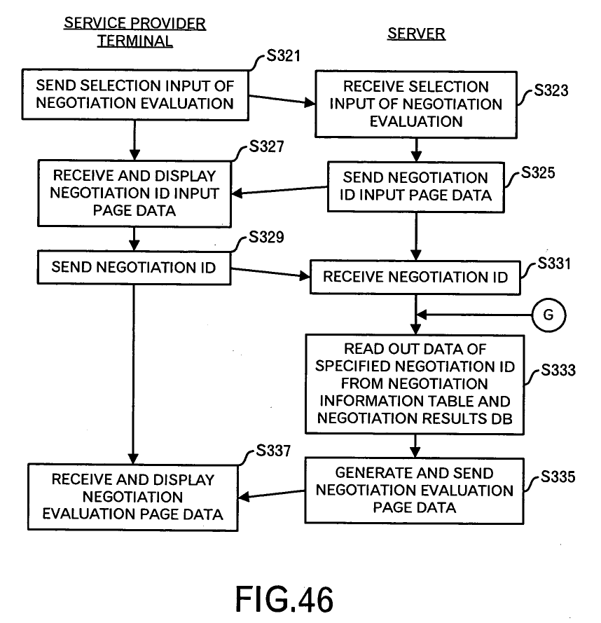

The service provider selects any of the negotiations, and clicks the negotiation name. The service provider terminal 7 accepts the selection input of the negotiation, and transmits the selection input of the negotiation to the server 5 (step S289). The negotiation data analyzer 52 of the server 5 receives the selection input of the negotiation from the service provider terminal 7 (step S291), and judges whether the return button 609 was clicked (step S293). The processing returns to the step S33 of FIG. 14 through the terminal A in a case where it is judged that the return button 609 was clicked. On the other hand, in a case where any of the negotiations is selected, the processing shifts to the processing of FIG. 46 through the terminal G.

Thus, the service provider can obtain information on the negotiation list, and is able to submit it to the sales manager.

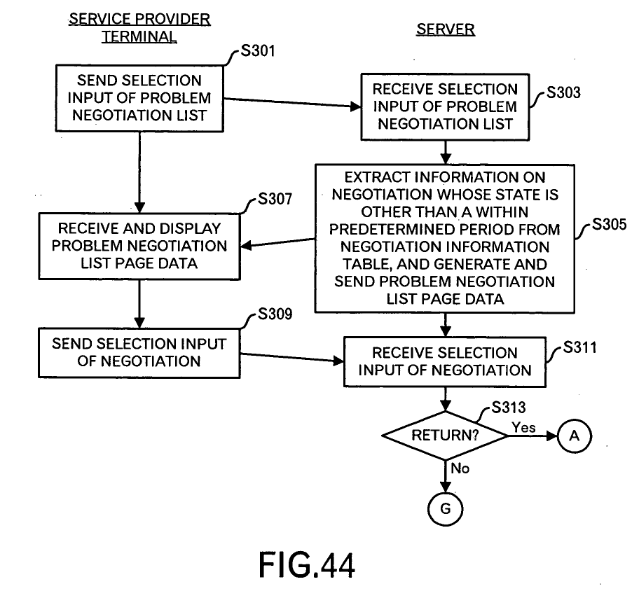

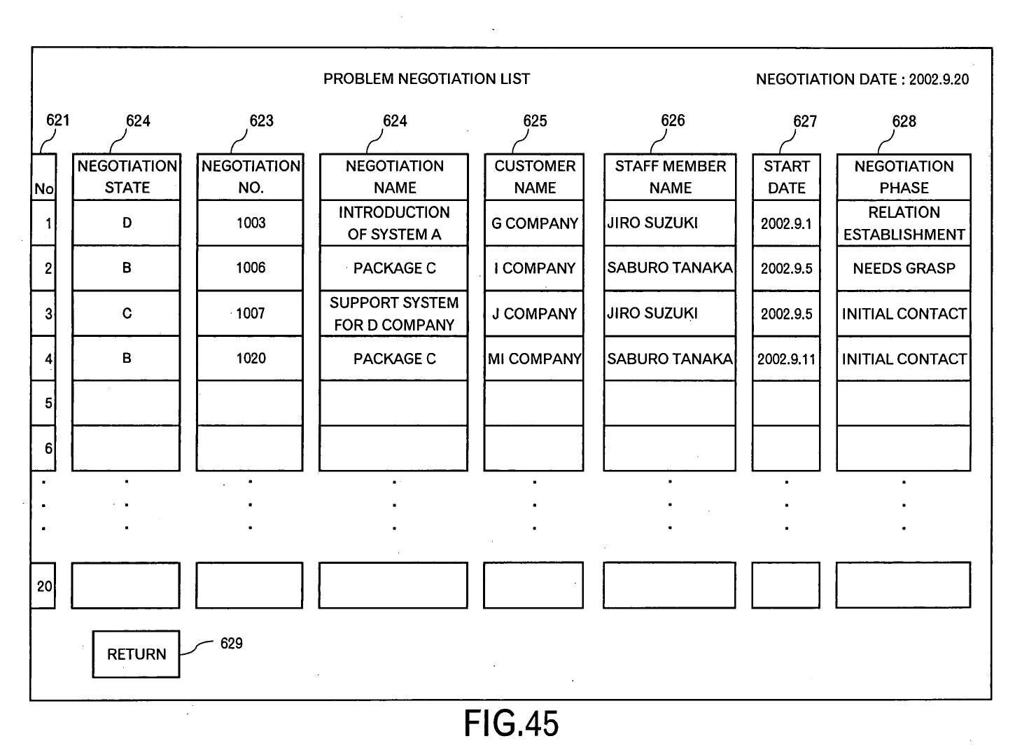

Next, the processing when the service provider selects “6. problem negotiation list” in the menu for the service provider is explained by using FIG. 44 and FIG. 45. The service provider terminal 7 accepts the selection input of the problem negotiation list display by the service provider, and transmits the selection input to the server 5 (step S301). The negotiation data analyzer 52 of the server 5 receives the selection input of the problem negotiation list (step S303). Then, it searches the negotiation results DB 69 and specifies IDs of the negotiations whose negotiation phase is changed in a predetermined period. In addition, it extracts the negotiation data of the negotiations whose negotiation state is other than A from the negotiation information table by using the specified negotiation IDs, and generates the problem negotiation list page data. Then, it transmits the generated problem negotiation list page data to the service provider terminal 7 (step S305). The service provider terminal 7 receives the problem negotiation list page data from the server 5, and displays it on the display device (step S307).

One example of the problem negotiation list page is shown in FIG. 45. In the example of FIG. 45, the page includes a table including a column 621 of the line number, a column 622 of the negotiation state, a column 623 of the negotiation number, a column 624 of the negotiation name, a column 625 of the customer name, a column 626 of the negotiation staff member name, a column 627 of the negotiation start date, and a column 628 of the current negotiation phase, and a return button 629.

Incidentally, a button to download the file for the print or the like may be provided. Moreover, each negotiation name of the column 624 of the negotiation name is a button, and when any of the negotiations is clicked, the transition to the evaluation page of the negotiation is carried out. In FIG. 45, because it is a problem negotiation list, the negotiations whose state is other than A and is judged as a problem negotiation are displayed in the list.

The service provider selects any of the negotiations, and clicks the negotiation name. The service provider terminal 7 accepts the selection input of the negotiation, and transmits the selection input of the negotiation to the server 5 (step S309). The negotiation data analyzer 52 of the server 5 receives the selection input of the negotiation from the service provider terminal 7 (step S311), and judges whether the return button 629 was clicked (step S313). The processing returns to the step S33 of FIG. 14 through the terminal A when it is judged that return button 629 was clicked. On the other hand, when any of the negotiations is selected, the processing shifts to the processing of FIG. 46 through the terminal G.

Thus, the service provider can obtain information on the problem negotiation list, and is able to submit it to the sales manager. The sales manager carries out appropriate measures such as the guidance to the sales staff member for the problem negotiation.

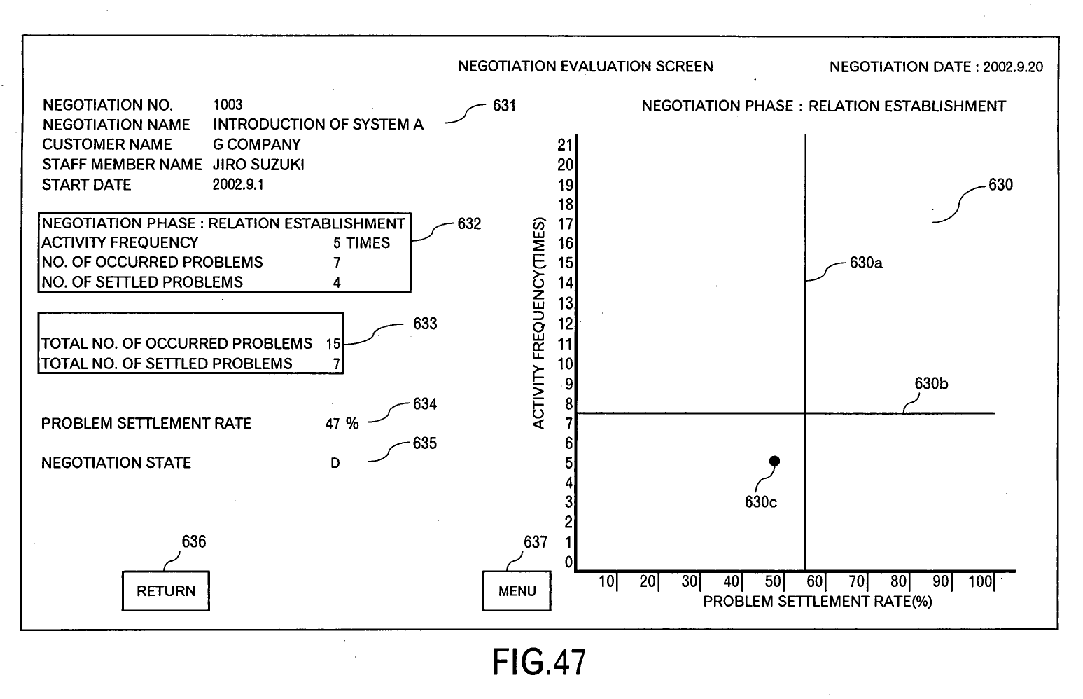

Next, the processing when the service provider selects “7. negotiation evaluation screen” in the menu for the service provider is explained by using FIG. 46 and FIG. 47. The service provider terminal 7 accepts the selection input of the negotiation evaluation by the service provider, and transmits the selection input to the server 5 (step S321). The negotiation data analyzer 52 of the server 5 receives the selection input of the negotiation evaluation from the service provider terminal 7 (step S323), and transmits the negotiation ID input page data to the service provider terminal 7 (step S325). The service provider terminal 7 receives the negotiation ID input page data from the server 5, and displays it on the display device (step S327). In the negotiation ID input page, the input column of the negotiation ID is provided, and a specific negotiation ID is input.

The service provider terminal 7 accepts the negotiation ID input by the service provider, and transmits it to the server 5 (step S329). The negotiation data analyzer 52 of the server 5 receives the negotiation ID from the service provider terminal 7 (step S331), and extracts the negotiation data of the specified negotiation ID from the negotiation information table and the negotiation results DB 69 (step S333). Then, it generates the negotiation evaluation page data, and transmits it to the service provider terminal 7 (step S335). The service provider terminal 7 receives the negotiation evaluation page data, and displays it on the display device (step S337).

One example of the negotiation evaluation page is shown in FIG. 47. In the example of FIG. 47, the page includes a graph 630 for the negotiation phase immediately before the current phase, a display column 631 of the negotiation basic information, a negotiation state display column 632 of the negotiation phase immediately before the current phase, a display column 633 of the total number of occurred problems and the total number of settled problems up to the negotiation phase immediately before the current phase, a display column 634 of the problem settlement rate up to the negotiation phase immediately before the current phase, a negotiation state display column 635 of the negotiation phase immediately before the current phase, a return button 636, and a menu button 637. A segment 630a that represents the threshold 1 of the negotiation phase immediately before the current phase, a segment 630b that represents the threshold 2 of the negotiation phase immediately before the current phase, and a point 630c that represents the negotiation state in the negotiation phase immediately before the current phase are shown in the graph 630. The threshold 1 and threshold 2 are read from the threshold DB 68. The position of the point 630c is determined according to the problem settlement rate up to the negotiation phase immediately before the current phase and the activity frequency in the negotiation phase immediately before the current phase. The activity frequency and the problem settlement rate are stored in the negotiation results DB 69. The negotiation basic information is stored in the negotiation information table. The data displayed in the negotiation state display column 632 of the negotiation phase immediately before the current phase, and in the display column 633 of the total number of occurred problems and the total number of settled problems up to the negotiation phase immediately before the current phase is stored in the negotiation results DB 69. The negotiation state and the problem settlement rate are also stored in the negotiation results DB 69.

The service provider clicks the return button 636 when returning to the negotiation ID input page. The menu button 637 is clicked when returning to the menu page for the service provider. The button to download the file for the negotiation evaluation page may be provided though it is not shown in the figure.

Thus, detailed information of the negotiation, which includes information of the negotiation state, can be obtained. When the service provider provides such information to the sales manager, the sales manager is able to carry out appropriate guidances to the sales staff members by considering detailed information on the negotiation.

Incidentally, the threshold 1 and threshold 2 are dynamically changed from objective data of the successful negotiation and the failed negotiation as stated above, and the difference of the judgment among the sales managers is lost. Moreover, the workload is reduced because the information gathering and analysis are automatically carried out by the aforementioned processing, thereby the sales manager can carry out an important work such as the strategy planning. In addition, the establishment of the best practice at the early stage becomes possible.

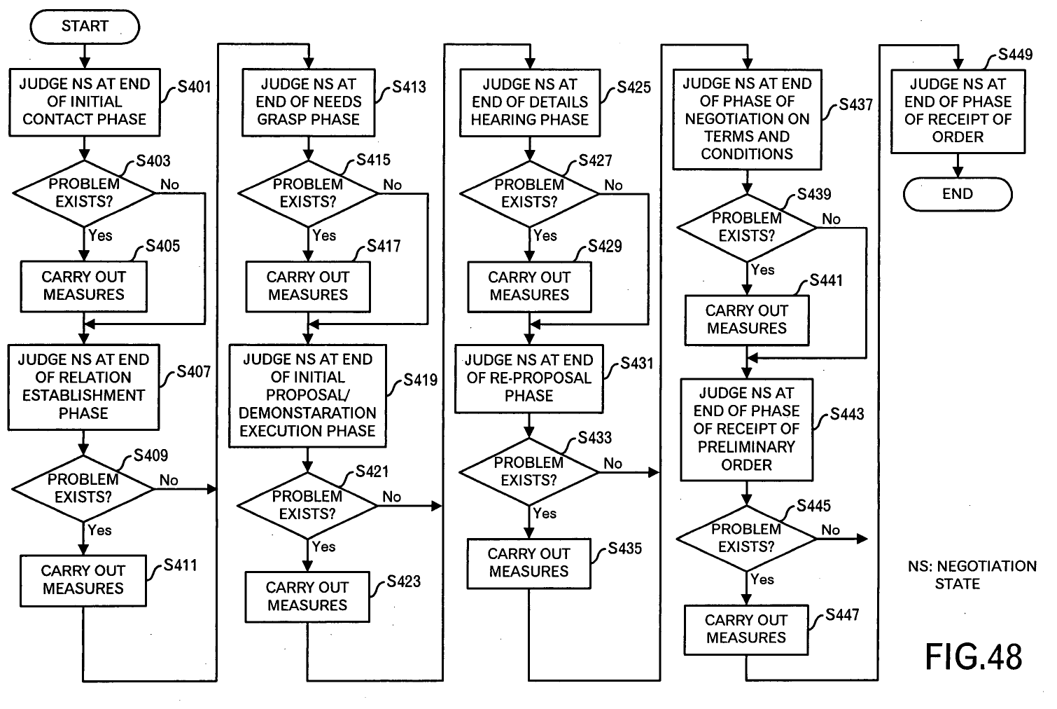

Incidentally, as for an individual negotiation, the processing shown in FIG. 48 will be executed. That is, when the initial contact phase ends, the negotiation state is judged (step S401). It is judged whether there is a problem as for the negotiation state at a predetermined timing (step S403). Because it is reported to the sales manager by the service provider when there is a problem, that is, the negotiation state is B, C or D, appropriate measures are carried out by the sales manager (step S405). Afterwards, when the relation establishment phase ends, the negotiation state is judged (step S407). Then, it is judged whether there is a problem as for the negotiation state at a predetermined timing (step S409). Because it is reported to the sales manager by the service provider when its is judged that there is a problem, appropriate measures are carried out by the sales manager (step S411). Afterwards, when the needs grasp phase ends, the negotiation state is judged (step S413). Moreover, it is judged whether there is a problem as for the negotiation state at a predetermined timing (step S415). Because it is reported to the sales manager by the service provider when it is judged that there is a problem, appropriate measures are carried out by the sales manager (step S417). Afterwards, when initial proposal/demonstration execution phase ends, the negotiation state is judged again (step S419). Moreover, it is judged whether there is a problem as for the negotiation state at a predetermined timing (step S421). Because it is reported to the sales manager by the service provider when it is judged that there is a problem, appropriate measures are carried out by the sales manager (step S423).

Afterwards, when the details hearing phase ends, the negotiation state is judged (step S425). Moreover, it is judged whether there is a problem as for the negotiation state at a predetermined timing (step S427). Because it is reported to the sales manager by the service provider when it is judged that there is a problem, appropriate measures are carried out by the sales manager (step S429). Afterwards, when the phase of the re-proposal ends, the negotiation state is judged (step S431). Moreover, it is judged whether there is a problem as for the negotiation state at a predetermined timing (step S433). Because it is reported to the sales manager by the service provider when it is judged that there is a problem, appropriate measures are carried out by the sales manager (step S435). Afterwards, when the phase of the negotiation on terms and conditions ends, the negotiation state is judged (step S437). Moreover, it is judged whether there is a problem in the negotiation state at a predetermined timing (step S439). Because it is reported to the sales manager by the service provider when it is judged that there is a problem, appropriate measures are carried out by the sales manager (step S441). Afterwards, when the phase of the preliminary receipt of the order ends, the negotiation state is judged (step S443). Moreover, it is judged whether there is a problem as for the negotiation state at a predetermined timing (step S445). Because it is reported to the sales manager by the service provider when it is judged that there is a problem, appropriate measures are carried out by the sales manager (step S447). Then, when the phase of the receipt of order ends, the negotiation state is judged (step S449). Then, the processing is ended.

Thus, because each negotiation is checked after each phase ends, whether the negotiation has progressed appropriately on each occasion can be confirmed. Because the report reaches the sales manager when the negotiation state is unpreferable, the measures will be appropriately carried out. Incidentally, in the last phase, the negotiation state may be checked on the way of that phase.

This invention is not limited to this though one embodiment of this invention is explained above. For instance, it is also possible to use not the activity frequency but stay time at the customer as an index though the activity frequency was used in the aforementioned embodiment. Moreover, the server 5 to achieve the above-mentioned function is configured by not only one computer but also a plurality of computers. In addition, though various examples of the screens are shown, these are mere examples, and it is also possible to adopt other screen configuration including a similar content. Moreover, though the first plane, in which the problem settlement rate corresponds to the X axis, and the activity frequency corresponds to the Y axis, is adopted, it is also possible to adopt the second plane in which the problem unsettled rate corresponds to the X axis, and the activity frequency corresponds to the Y axis. When the second plane is adopted, the region correspondence is changed between the first plane and the second plane. Moreover, not only the plane but also the space with three or more dimensions may be adopted.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A business management method, comprising:
based on data received from a terminal of a staff member, registering data concerning an activity state of said staff member and data concerning a settlement state of problems in a work that said staff member is doing, into a storage device;
judging suitability of said work that said staff member is doing, by using a predetermined rule, which is stored in a rule storage, for at least said activity state and said settlement state of said problems, and said data registered in said storage device; and
transmitting a manager terminal data representing said suitability of said work that said staff member is doing.

2. A business management method, comprising:
based on data received from a terminal of a staff member, registering data concerning an activity state of said staff member and data concerning a settlement state of problems in a work that said staff member is doing, into a storage device;
judging suitability of said work that said staff member is doing by using a predetermined rule, which is stored in a rule storage, for at least said activity state and said settlement state of said problems, and data stored in said storage device; and
specifying either of said work, which is judged that there is no suitability, and said staff member, who is doing said work, and transmitting data concerning either of the specified work and the specified staff member to a manager terminal.

3. A business management method, comprising:
based on data received from a terminal of a staff member, registering data concerning an activity state in each phase of a negotiation and data concerning a settlement state of problems in said negotiation, into a negotiation data storage;
judging possibility of a success or failure of a negotiation to be processed by using a first condition concerning said activity state set for each phase, a second condition concerning said settlement state of said problems set for each phase, and data registered in said negotiation data storage; and
transmitting data representing said possibility of the success or failure of said negotiation to be processed in a specific phase to a manager terminal.

4. The business management method as set forth in claim 3, wherein said data concerning said activity state is either of a number of visits to a customer and a staying time at said customer.

5. The business management method as set forth in claim 3, wherein said data concerning said settlement state of said problems is any of a set of a number of occurred problems and a number of settled problems, a problem settlement rate, and a problem unsettlement rate.

6. The business management method as set forth in claim 3, wherein said judging comprises:
comparing a first condition concerning said activity state in said specific phase with said data concerning said activity state in said specific phase of said negotiation to be processed; and
comparing a second condition concerning said settlement state of said problems in said specific phase with said data concerning said settlement state of said problems up to said specific phase of said negotiation to be processed.

7. The business management method as set forth in claim 6, wherein said data representing said possibility of the success or failure includes data representing a region, to which said negotiation to be processed belongs, among a plurality of regions in a plane, wherein said plane is mapped with an axis for said data concerning said activity state and an axis for said data concerning said settlement state of said problems, and said plurality of regions are obtained by dividing said plane by said first condition concerning said activity state and said second condition concerning said settlement state of said problems.

8. The business management method as set forth in claim 3, wherein said first condition concerning said activity state is calculated based on data concerning said activity state in each phase of past successful negotiations and data concerning said activity state in each phase of past failed negotiations, and said second condition concerning said settlement state of said problems is calculated based on data concerning said settlement state of said problems in each phase of said past successful negotiations and data concerning said settlement state of said problems in each phase of said past failed negotiations.

9. The business management method as set forth in claim 3, further comprising specifying a negotiation whose possibility of the success or failure is under a predetermined reference, and transmitting data of the specified negotiation to said manager terminal.

10. The business management method as set forth in claim 3, wherein said data received from said terminal of said staff member is data of a business daily report.

11. The business management method as set forth in claim 7, further comprising transmitting said manager terminal data in which said first condition concerning said activity state, said second condition concerning said settlement state of said problems, and a position data of said negotiation to be processed in said specific phase are disposed in said plane.

12. A business management method, comprising:
based on data received from a terminal of a staff member, registering data concerning an activity state in each phase of a negotiation and data concerning a settlement state of problems in said negotiation into a negotiation data storage;
judging possibility of a success or failure of a negotiation to be processed by using a first condition concerning said activity state set for each phase, a second condition concerning said settlement state of said problems set for each phase, and data registered in said negotiation data storage; and
specifying a negotiation whose possibility of the success or failure is under a predetermined reference, and transmitting data of the specified negotiation to a manager terminal.

13. A computer program embodied on a medium for a business management method, said computer program comprising:
based on data received from a terminal of a staff member, registering data concerning an activity state of said staff member and data concerning a settlement state of problems in a work that said staff member is doing, into a storage device;
judging suitability of said work that said staff member is doing, by using a predetermined rule, which is stored in a rule storage, for at least said activity state and said settlement state of said problems, and said data registered in said storage device; and
transmitting a manager terminal data representing said suitability of said work that said staff member is doing.

14. A computer program embodied on a medium for a business management method, said computer program comprising:
based on data received from a terminal of a staff member, registering data concerning an activity state of said staff member and data concerning a settlement state of problems in a work that said staff member is doing, into a storage device;
judging suitability of said work that said staff member is doing by using a predetermined rule, which is stored in a rule storage, for at least said activity state and said settlement state of said problems, and data stored in said storage device; and
specifying either of said work, which is judged that there is no suitability, and said staff member, who is doing said work, and transmitting data concerning either of the specified work and the specified staff member to a manager terminal.

15. A computer program embodied on a medium for a business management method, said computer program comprising:
based on data received from a terminal of a staff member, registering data concerning an activity state in each phase of a negotiation and data concerning a settlement state of problems in said negotiation, into a negotiation data storage;
judging possibility of a success or failure of a negotiation to be processed by using a first condition concerning said activity state set for each phase, a second condition concerning said settlement state of said problems set for each phase, and data registered in said negotiation data storage; and
transmitting data representing said possibility of the success or failure of said negotiation to be processed in a specific phase to a manager terminal.

16. The computer program as set forth in claim 15, wherein said judging comprises:
comparing a first condition concerning said activity state in said specific phase with said data concerning said activity state in said specific phase of said negotiation to be processed; and
comparing a second condition concerning said settlement state of said problems in said specific phase with said data concerning said settlement state of said problems up to said specific phase of said negotiation to be processed.

17. The computer program as set forth in claim 15, wherein said first condition concerning said activity state is calculated based on data concerning said activity state in each phase of past successful negotiations and data concerning said activity state in each phase of past failed negotiations, and said second condition concerning said settlement state of said problems is calculated based on data concerning said settlement state of said problems in each phase of said past successful negotiations and data concerning said settlement state of said problems in each phase of said past failed negotiations.

18. A business management apparatus, comprising:
means for registering, based on data received from a terminal of a staff member, data concerning an activity state of said staff member and data concerning a settlement state of problems in a work that said staff member is doing, into a storage device;
means for judging suitability of said work that said staff member is doing, by using a predetermined rule, which is stored in a rule storage, for at least said activity state and said settlement state of said problems, and said data registered in said storage device; and
means for transmitting a manager terminal data representing said suitability of said work that said staff member is doing.

19. A business management apparatus, comprising:
means for registering, based on data received from a terminal of a staff member, data concerning an activity state of said staff member and data concerning a settlement state of problems in a work that said staff member is doing, into a storage device;
means for judging suitability of said work that said staff member is doing by using a predetermined rule, which is stored in a rule storage, for at least said activity state and said settlement state of said problems, and data stored in said storage device; and
means for specifying either of said work, which is judged that there is no suitability, and said staff member, who is doing said work, and transmitting data concerning either of the specified work and the specified staff member to a manager terminal.

20. A business management apparatus, comprising:
means for registering, based on data received from a terminal of a staff member, data concerning an activity state in each phase of a negotiation and data concerning a settlement state of problems in said negotiation, into a negotiation data storage;
means for judging possibility of a success or failure of a negotiation to be processed by using a first condition concerning said activity state set for each phase, a second condition concerning said settlement state of said problems set for each phase, and data registered in said negotiation data storage; and
means for transmitting data representing said possibility of the success or failure of said negotiation to be processed in a specific phase to a manager terminal.

21. The business management apparatus as set forth in claim 20, wherein said means for judging comprises:
means for comparing a first condition concerning said activity state in said specific phase with said data concerning said activity state in said specific phase of said negotiation to be processed; and
means for comparing a second condition concerning said settlement state of said problems in said specific phase with said data concerning said settlement state of said problems up to said specific phase of said negotiation to be processed.

22. The business management apparatus as set forth in claim 20, wherein said first condition concerning said activity state is calculated based on data concerning said activity state in each phase of past successful negotiations and data concerning said activity state in each phase of past failed negotiations, and said second condition concerning said settlement state of said problems is calculated based on data concerning said settlement state of said problems in each phase of said past successful negotiations and data concerning said settlement state of said problems in each phase of said past failed negotiations.
